(19) United States
(12) Patent Application Publication
(10) Pub. No.: US 2012/0039691 A1
(43) Pub. Date: Feb. 16, 2012

(54) SYSTEMS FOR TREATING A SUBSTRATE

(76) Inventors: KISANG KIM, Seongnam-si (KR); Taehyuk Ahn, Yongin-si (KR); Donggun Park, Seoul (KR); Sangwoun Lee, Suwon-si (KR); Bongsun Kim, Hwaseong-si (KR)

(21) Appl. No.: 13/208,032

(22) Filed: Aug. 11, 2011

(30) Foreign Application Priority Data
Aug. 12, 2010 (KR) 10-2010-0077941
Feb. 16, 2011 (KR) 10-2011-0013853

(51) Int. Cl. B65G 49/00

(52) U.S. Cl. 414/222.01

(57) ABSTRACT

The present inventive concept provides a substrate treating system. The substrate treating system has a plurality of process facilities and at least one buffer station. Each of the process facilities respectively includes a transfer module in which a transfer robot is provided and a treating module connected to the transfer module. A buffer station is located between each of adjacent transfer modules. The buffer stations are provided to transfer substrates between the transfer modules. The plurality of process facilities includes a first facility in which the treating module is located on a first side of an imaginary connection line provided along a direction in which the transfer modules and the buffer stations are arranged and a second facility in which the treating module is located on a second side of the imaginary connection line. The transfer module of the first facility further protrudes toward the first side of the imaginary connection line farther than the transfer module of the second facility.

### CROSS-REFERENCE TO RELATED APPLICATIONS

This U.S. non-provisional patent application claims priorities under 35 U.S.C. §119 to Korean Patent Application No. 10-2010-0077941, filed on Aug. 12, 2010, and Korean Patent Application No. 10-2011-0013853, filed on Feb. 16, 2011, the entire contents of which are hereby incorporated by reference.

### BACKGROUND

The present inventive concept herein relates to systems for treating a substrate, and more particularly, to systems for treating a substrate between a plurality of process facilities including a transfer module.

Semiconductor processes are performed in a plurality of process facilities provided in clean environments, such as a clean room. Each of the process facilities may include a load port, a transfer module and a treating module. A vessel including substrates is placed on the load port. The transfer module is arranged between the load port and the treating module and may include a transfer robot returning a substrate between a vessel placed on the load port and the treating module. An example of the process facility described above is disclosed in U.S. Published Patent No. 2008/0255697, which is commonly owned by the assignee of the instant application and is incorporated by reference herein.

The process facilities are arranged to be separated from one another in a clean room. Substrates on a vessel are transferred between the process facilities by a return device or a worker.

### SUMMARY

Embodiments of the inventive concept provide a substrate treating system. The substrate treating system includes a plurality of process facilities respectively including a transfer module in which a transfer robot is provided and a treating module connected to the transfer module. The substrate treating system also includes a buffer station located between each of adjacent transfer modules and provided to transfer substrates between the transfer modules. The plurality of process facilities includes at least one first facility in which the treating module is located on a first side of an imaginary connection line provided along a direction in which the transfer modules and the buffer station are arranged, and at least one second facility in which the treating module is located on a second side of the imaginary connection line. The transfer module of the first facility protrudes toward the first side of the imaginary connection line farther than the transfer module of the second facility.

Embodiments of the inventive concept also provide a substrate treating system that includes a first transfer module into which a first transfer robot is provided, a second transfer module into which a second transfer robot is provided, a buffer station disposed between the first transfer module and the second transfer module and provided to transfer a substrate between the first and second modules, a first treating module combined with the first transfer module while being disposed on a first side of an imaginary connection line, wherein the imaginary connection line extends in a direction in which the first transfer module, the first buffer station and the second transfer module are arranged, and a second treating module combined with the second transfer module while being disposed on a second side of the imaginary connection line. The first transfer module protrudes toward the first side of the imaginary connection line farther than the second transfer module.

Embodiments of the inventive concept also provide a substrate treating system, comprising a first transfer module, a second transfer module, a buffer station interposed between the first and second transfer modules, wherein the first and second transfer modules, and the buffer station are arranged along an imaginary line extending along a first axis, a first treating module disposed on a first side of the imaginary line along a second axis perpendicular to the first axis, and a second treating module disposed on a second side of the imaginary line along the second axis, wherein a side of the first transfer module on the first side of and extending parallel to the imaginary line is farther from the imaginary line than a side of the second transfer module on the first side of and extending parallel to the imaginary line.

### BRIEF DESCRIPTION OF THE FIGURES

The foregoing and other features of the inventive concept will be apparent from the more particular description of aspects of the invention, as illustrated in the accompanying drawings in which like reference characters may refer to the same or similar parts throughout the specification. In the drawings, the thickness of layers and regions may be exaggerated for clarity.

FIG. 1 is a top plan view illustrating an example of a substrate treating system.

FIG. 2 is a cross sectional view illustrating internal structures of a transfer module and a buffer station.

FIG. 3 is a perspective view illustrating an example of a buffer member of FIG. 2.

FIG. 4 is a perspective view illustrating another example of the buffer member of FIG. 2.

FIG. 5 is a perspective view illustrating an example of a buffer station of FIG. 1.

FIG. 6 is a top plan view illustrating another example of the buffer station of FIG. 1.

FIGS. 7 and 8 are perspective views illustrating other examples of the buffer station of FIG. 1, respectively.

FIG. 9 is a drawing for describing a shape of a transfer module in a substrate treating system.

FIGS. 10 through 15 are top plan views illustrating other examples of a substrate treating system, respectively.

FIG. 16 illustrates an example of a substrate treating device of FIG. 15.

FIGS. 17 through 19 are top plan views illustrating other examples of a substrate treating system, respectively.

FIG. 20 is a drawing illustrating an example of a substrate treating device of FIG. 19.

FIGS. 21 through 23 are top plan views illustrating other examples of a substrate treating system.

FIGS. 24 through 26 are top plan views illustrating an example of a plurality of substrate treating systems.

FIGS. 27 through 29 illustrate returning paths of a substrate in a substrate treating system, respectively.

### DETAILED DESCRIPTION OF THE EMBODIMENTS

Embodiments of the inventive concept will be described below in more detail with reference to the accompanying drawings. The embodiments of the inventive concept may, however, be embodied in different forms and should not be constructed as limited to the embodiments set forth herein. . In the drawings, the shapes of elements may be exaggerated for clarity. Like numbers may refer to like elements throughout.

As will be appreciated by one skilled in the art, aspects of the present inventive concept may be embodied as a system, method or computer program product. Accordingly, aspects of the present inventive concept may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present inventive concept may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a RAM, a ROM, an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present inventive concept may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present inventive concept are described with reference to flowchart illustrations and/or block diagrams of methods, apparatus (systems) and computer program products according to embodiments of the inventive concept. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article or manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present inventive concept. In this regard, each block in the flowchart or block diagrams may represent a module, segment, or portion of code, which comprises one or more executable instructions for implementing the specified logical functions(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

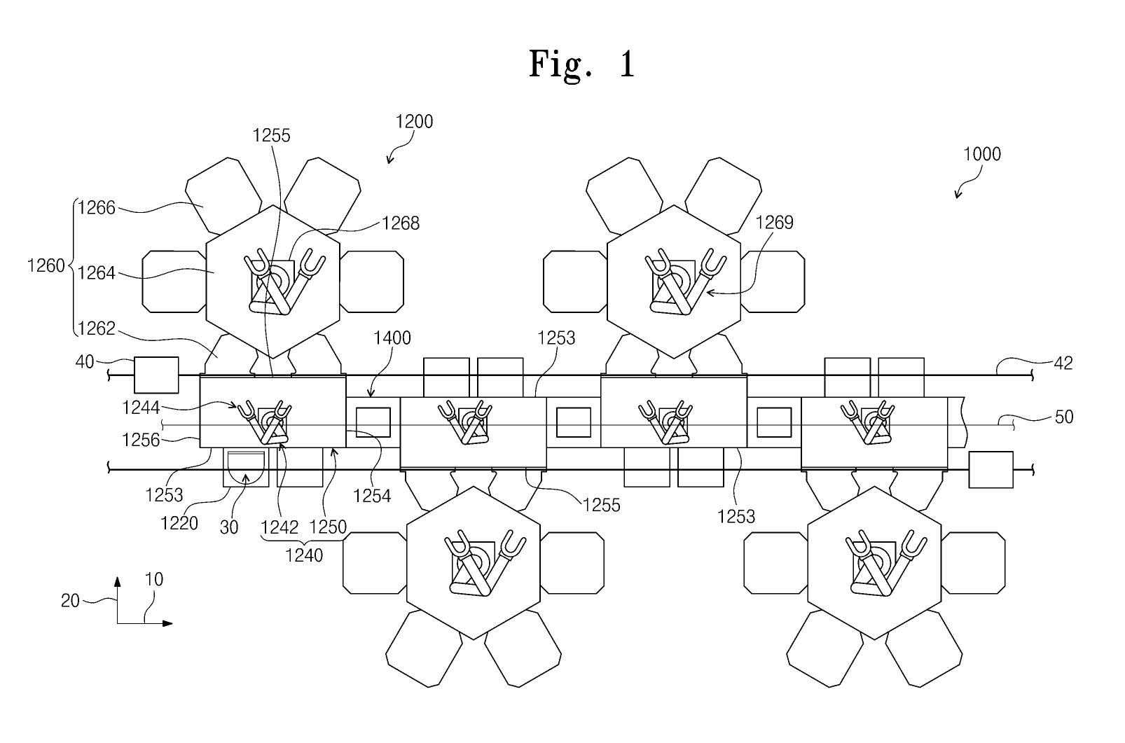

FIG. 1 is a perspective view illustrating a substrate treating system 1000 in accordance with an embodiment of the inventive concept. Referring to FIG. 1, the substrate treating system 1000 includes a plurality of process facilities 1200 and a plurality of buffer stations 1400. Each of the process facilities 1200 includes a load port 1220, a transferring module 1240 and a treating module 1260. According to an embodiment, in the process facility 1200, the load port 1220, the transferring module 1240 and the treating module 1260 are sequentially arranged in a straight line. The transfer modules 1240 that belong to other process facilities 1200 are arranged with one another in a straight line. The buffer station 1400 is disposed between transfer modules 1240 of adjacent process facilities 1200. When viewed from a top plan view, in the process facility 1200, a direction in which the load port 1220, the transfer module 1240 and the treating module 1260 are arranged is perpendicular to a direction in which the transfer modules 1240 and the buffer station 1400 are arranged. Referring to the legend in FIG. 1, the direction in which the transfer modules 1240 and the buffer station 1400 are arranged is called a first direction 10 and the direction in which the load port 1220, the transfer module 1240 and the treating module 1260 are arranged is called a second direction 20.

In operation, a vessel 30 including substrates is placed on the load port 1220. According to an embodiment, the vessel 30 is loaded or unloaded by a return device 40 like an overhead transfer. The vessel 30 may be selectively loaded or unloaded on the load port 1220 by an automatic guided vehicle, a rail guided vehicle or a worker. A front open unified pod, which is a closed type vessel, may be used as the vessel 30. In each process facility 1200, one or a plurality of the load ports 1220 are provided. In the case that a plurality of the load ports 1220 are provided, the load ports 1220 are provided in a line along the first direction 10. In FIG. 1, two load ports 1220 for each process facility 1200 are shown. However, a quantity of the load ports 1220 provided to each of the process facilities 1200 may be different. Also, the process facilities 1200 may have a different quantity of load ports 1220 from one another.

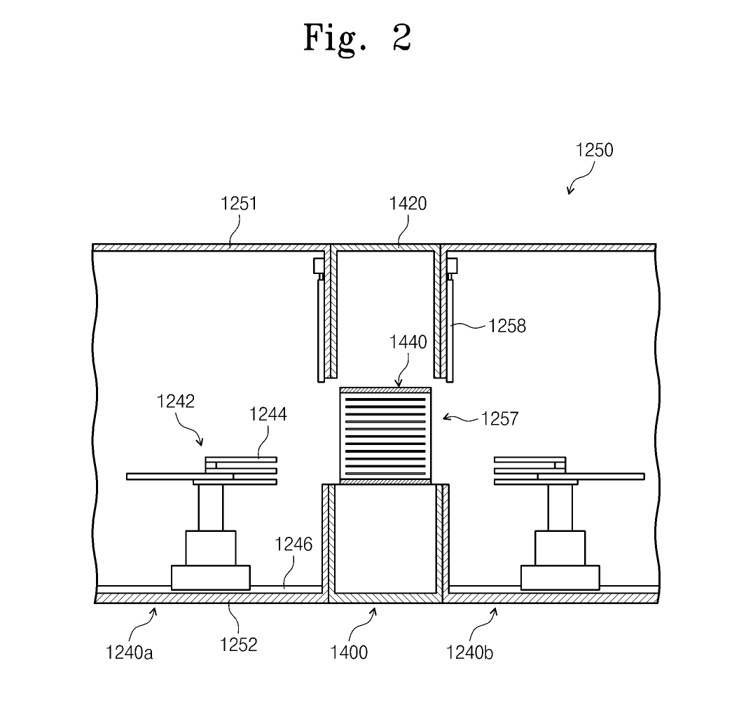

The transfer module 1240 includes a housing 1250 and a transfer robot 1242. The housing 1250 has a substantially rectangular shape. Referring to FIGS. 1 and 2, the housing 1250 has a top surface (1251 of FIG. 2), a bottom surface (1252 of FIG. 2), a first side 1253, a second side 1254, a third side 1255 and a fourth side 1256. The first and third sides 1253 and 1255 face each other and the second and fourth sides 1254 and 1256 face each other. The first side 1253 is perpendicular to the second side 1254. The first side 1253 faces the load port 1220 and the third side 1255 faces the treating module 1260.

An opening (not shown) access to a substrate in the vessel 30 and a door (not shown) for opening and closing the opening is provided at the first side 1253 of the housing 1250. An opening (not shown) for an access to a substrate in the treating module 1260 and a door (not shown) for opening and closing the opening is provided at the third side 1255 of the housing 1250. Also, openings (1257 of FIG. 2) for access to a substrate in the buffer station 1400 are formed on the second and/or fourth sides of the housing 1250, respectively. A door opener (not shown) for opening a door of the vessel 30 is provided in the housing 1250. The housing 1250 is provided so that an inner region of the housing 1250 is isolated from the outside. A fan filter unit (not shown) is provided on the top surface of the housing 1250 and the fan filter unit guide air filtered in the housing 1250 so that it flows in a direction from top to bottom. Accordingly, the inside of the housing 1250 may be maintained to be cleaner than the outside of the housing 1250.

The transfer robot 1242 transfers a substrate between the vessel 30 placed on the load port 1220 and the treating module 1260, between the load port 1220 and the buffer station 1400 and between the treating module 1260 and the buffer station 1400. A guide rail 1246 is provided in the housing 1250 to be parallel to the first direction 10. The transfer robot 1242 is located on the guide rail 1246 to move in a straight line along the guide rail 1246. According to an embodiment, the transfer robot 1242 also moves up and down. A hand 1244 of the transfer robot 1242 can move forward, move backward and rotate on a horizontal plane. One or more hands 1244 may be provided. In FIG. 1, the transfer robot 1242 having two hands 1244 is shown.

The treating module 1260 includes a load-lock chamber 1262, a transfer chamber 1264 and a process chamber 1266.

The transfer chamber 1264 has a substantially polygonal shape when viewed from a top plan view. In FIG. 1, it is illustrated that the transfer chamber 1264 has a hexagonal shape when viewed from a top plan view. However, a shape of the transfer chamber 1264 is not limited thereto, and may be changed. A transfer robot 1268 is provided in the transfer chamber 1264. The transfer robot 1268 can move up and down and a hand 1269 of the transfer robot 1268 can move forward, move backward and rotate on a horizontal plane. One or more hands 1269 may be provided. In FIG. 1, the transfer robot 1268 having two hands 1268 is shown.

The load-lock chambers 1262 and the process chambers 1266 are provided around the transfer chamber 1264. The load-lock chambers 1262 are located at side portions of the transfer chamber 1264 adjacent to the transfer module 1240. The process chambers 1266 are located at the other side portions of the transfer chamber 1264. One or more load-lock chambers 1262 may be provided. According to an embodiment, two load-lock chambers 1262 are provided. Substrates to be inputted in the treating module 1260 to perform a process may be temporally placed in one of the load-lock chambers 1262 and substrates outputted from the treating module 1260 after a process is completed may be temporally placed in the other of the load-lock chambers 1262. Substrates before performing a process and after completing a process may be placed in each of the load-lock chambers 1262. The insides of the transfer chamber 1264 and the process chambers 1266 are maintained at a first pressure, the inside of the transfer module 1240 is maintained at a second pressure and the inside of the load-lock chamber 1262 may be varied between the first pressure and the second pressure. According to an embodiment, the first pressure is lower than the second pressure. For instance, the first pressure is a vacuum pressure and the second pressure is an atmospheric pressure.

A process chamber 1266 performs a predetermined process on a substrate. For example, the process chamber 1266 may perform processes such as cleaning, ashing, deposition, etching or measuring. One or more of the process chambers 1266 may be provided. For example, the process chambers 1266 may be provided to all or a portion of the other side portions, except those side portions of the transfer chamber 1264 to which the load-lock chambers 1262 are provided. In the case that a plurality of process chambers 1266 are provided, the process chambers 1266 may perform a same process or different processes on the substrate. The process chambers 1266 may have structures performing processes on the substrate at, for example, a vacuum pressure, or at atmospheric pressure.

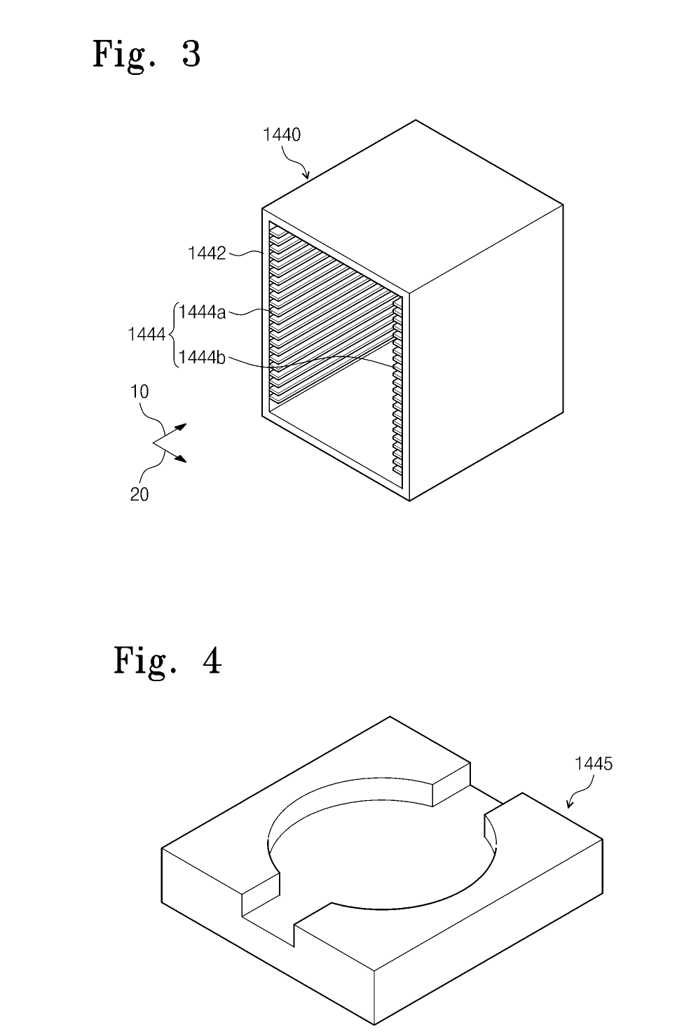

The buffer station 1400 is provided between adjacent transfer modules (e.g., 1240a, 1240b). FIG. 2 is a drawing illustrating an example of a buffer station 1400 provided between transfer modules (1240a, 1240b). FIG. 3 is a perspective view illustrating an example of a buffer member 1440 of FIG. 2. Referring to FIGS. 2 and 3, the buffer station 1400 includes a housing 1420 and a buffer member 1440. According to an embodiment, the housing 1420 has a rectangular container shape having a space therein. One end of the housing 1420 is combined with a first transfer module 1240a and the other end of the housing 1420 is combined with a second transfer module 1240b. One end and the other end of the housing 1420 are spaced apart from each other along the first direction 10 and face each other.

According to an embodiment, the buffer member 1440 is fixedly installed in the housing 1420. The buffer member 1440 includes a body 1442 and a plurality of buffers 1444. The body 1442 has a rectangular container shape and some of the sides (e.g., two sides) perpendicular to the first direction 10 are open. The buffers 1444 are provided inside the body 1442. The buffers 1444 are spaced apart from each other in an up-and-down direction. Each of the buffers 1444 includes two plates 1444a and 1444b supporting an edge portion of the substrate. The plates 1444a and 1444b are spaced apart from each other along the second direction 20. A hand 1244 of a transfer robot 1242 moves up and down along a separated space between the plates (1444a, 1444b). The transfer robots 1242 of the transfer modules 1240a, 1240b located at both sides of the buffer station 1400 are provided to load or unload the substrates. According to an embodiment, the buffer member 1440 may have a buffer 1445 like that shown in FIG. 4.

Referring back to FIG. 2, doors 1258 opening and closing respective openings 1257 formed on a side facing the buffer station 1400 are provided in the housings 1250 of the transfer modules (1240a, 1240b). In the event that an error occurs in one of the process facilities 1200, an opening 1257 is closed using the door 1258 and each process facility 1200 may be used independently of other process facilities 1200. In this case, a transfer of the substrate in a vessel 30 between the process facilities 1200 may be performed through the overhead transfer 40. As an alternative, the vessel 30 including the substrate may be transferred between the process facilities 1200 using an automatic guided vehicle, a rail guided vehicle or a worker.

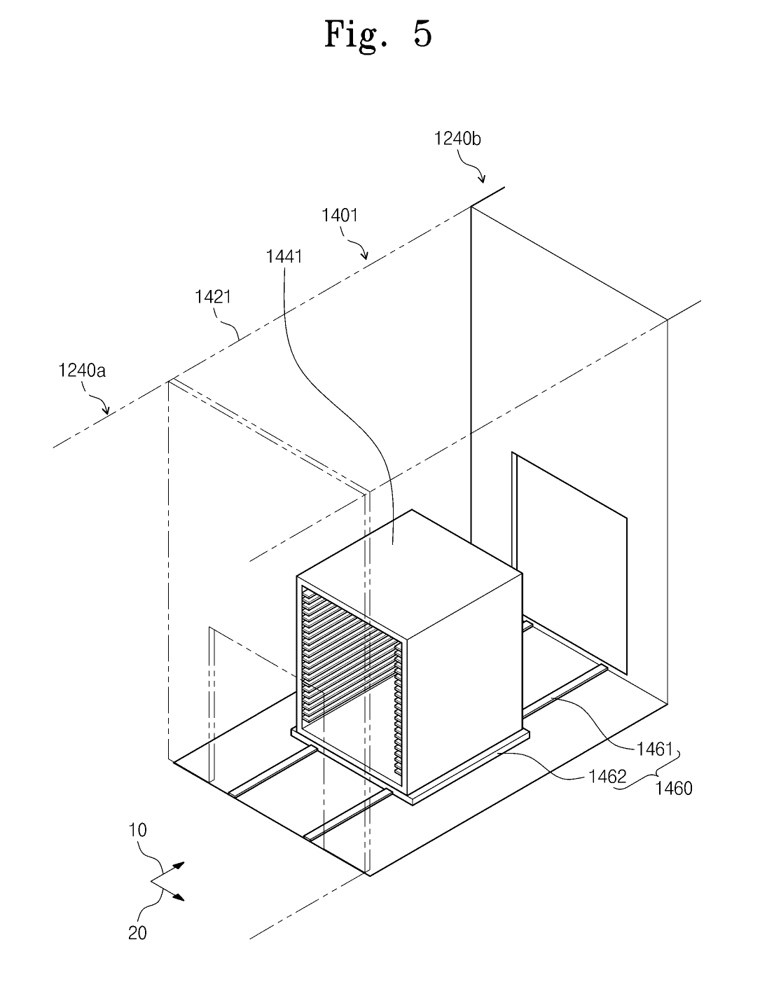

FIG. 5 is a drawing illustrating another example of a buffer station 1401. In FIG. 5, the housing 1421 is removed to show the inside of the buffer station 1401. Referring to FIG. 5, the buffer station 1401 includes a housing 1421, a buffer member 1441 and a buffer driving member 1460. The housing 1421 and the buffer member 1441 in FIG. 5 have a similar structure to the housing 1420 and the buffer member 1440 in FIGS. 2 and 3. The housing 1421 of FIG. 5 has a greater length along the first direction 10 compared with the housing 1420 of FIG. 2. The buffer driving member 1460 moves the buffer member 1441 from a first location to a second location along the first direction 10 in the housing 1421. The first location is a location adjacent to a transfer module 1240a (also referred to as “a first transfer module”) located at one side of the buffer station 1401 and the second location is a location adjacent to another transfer module 1240b (also referred to as “a second transfer module”) located at the other side of the buffer station 1401. The buffer driving member 1460 includes a guide rail 1461 and a base 1462. A lengthwise direction of the guide rail 1461 is arranged in the housing 1421 to be parallel to the first direction 10 and extends from the first location to the second location. The base 1462 is combined with the guide rail 1461 so that it can move along the guide rail 1461 by a driver (not shown). The buffer member 1441 is fixedly combined with the base 1462 to move together with the base 1462. The buffer station 1401 of FIG. 5 may be used when a distance between the adjacent transfer modules 1240a and 1240b is relatively far.

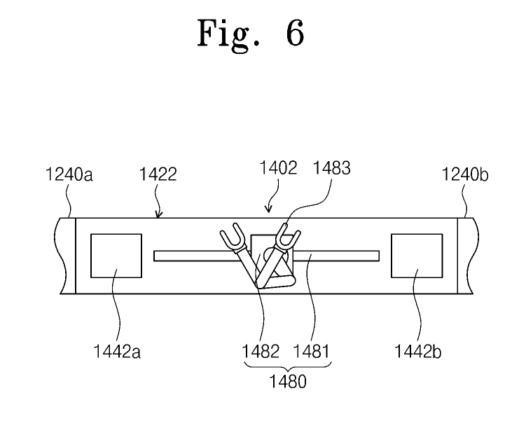

FIG. 6 is a top plan view illustrating another example of a buffer station 1402. Referring to FIG. 6, the buffer station 1402 includes a housing 1422, a first buffer member 1422a, a second buffer member 1442b and a return member 1480. The housing 1422 of FIG. 6 has a structure similar to the housing 1420 of FIG. 2. The first buffer member 1442a and the second buffer member 1442b have a structure similar to the buffer member 1440 of FIG. 3. However, the housing 1422 of FIG. 6 has a greater length along a first direction 10 compared with the housing 1420 of FIG. 2. The first buffer member 1442a is located adjacent to the first transfer module 1240a disposed on one side of the buffer station 1402. The second buffer member 1442b is located adjacent to the second transfer module 1240b disposed on the other side of the buffer station 1402. The return member 1480 transfers a substrate between the first buffer member 1442a and the second buffer member 1442b. The return member 1480 has a guided rail 1481 and a transfer robot 1482. The guided rail 1481 is disposed in the housing 1422 so that a lengthwise direction of the guided rail 1481 is parallel to the first direction 10. The guided rail 1481 extends from a position adjacent to the first buffer member 1442a to a position adjacent to the second buffer member 1442b. The transfer robot 1482 is combined with the guided rail 1481 so that the transfer robot 1482 can be transferred along the guided rail 1481 by a driver (not shown). The transfer robot 1482 transfers a substrate from the first buffer member 1442a to the second buffer member 1442b. The transfer robot 1482 has one or a plurality of hands 1483. For instance, the transfer robot 1482 may have two hands or may have as many hands as the number of substrates that can be loaded on the first buffer member 1442a. The buffer station 1402 of FIG. 6 may be used when a distance between the adjacent transfer modules 1240a, 1240b is comparatively long.

Referring back to FIG. 1, according to an embodiment, the buffer station 1400 is a single body with the transfer modules 1240. As an alternative, the buffer station 1400 may be readily attached to and detached from the transfer modules 1240.

According to an embodiment, the substrate treating system 1000 is installed as follows. The process facility 1200 and the buffer station 1400 are sequentially and repeatedly installed until the last process facility 1200 is installed. When installing the buffer station 1400, the buffer station 1400 is installed to connect with the transfer module 1240 of an adjacent installed the process facility 1200, and when installing the process facility 1200, the transfer module 1240 is installed to connect with an adjacent installed buffer station 1400. Then, the transfer module 1240 and the buffer station 1400 are fixed using a combination member (not shown) such as, for example, a screw.

As an alternative, the substrate treating system 1000 is installed as follows. First, the process facilities 1200 are installed so that the transfer modules 1240 are located to be spaced apart from one another at regular intervals. After that, the buffer stations 1400 are located between the transfer modules 1240. According to an embodiment, a length of the buffer stations 1400 along the first direction 10 may be adjustable. After the buffer stations 1400 are located between the transfer modules 1240, a length of the buffer station 1400 is adjusted (e.g., increased) to connect to an adjacent transfer module 1240. Then, the transfer module 1240 and the buffer station 1400 are fixed using a combination member (not shown) such as, for example, a screw.

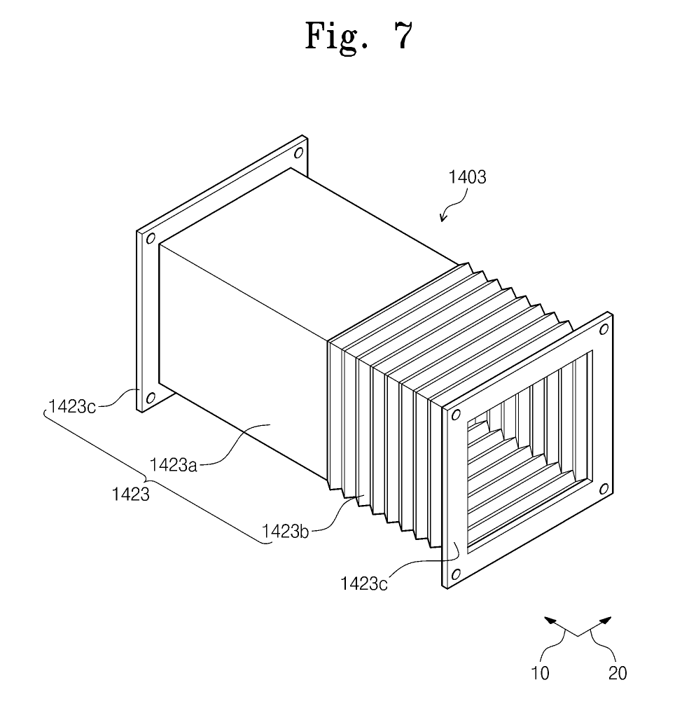

FIG. 7 is a perspective view illustrating an example of a buffer station 1403 of which a length is adjustable. Referring to FIG. 7, a housing 1423 of the buffer station 1403 includes a body 1423a, a bellows 1423b and a combination plate 1423c. The body 1423a has a structure or a material such that a length of the body 1244a along the first direction 10 is fixed. The bellows 1423b extends from the body 1423a and a length of the bellows 1423b may be changed along the first direction 10. A combination plate 1423c is provided at an end of the body 1423a and at an end of the bellows 1423b. To combine the buffer station 1403 with the transfer modules 1240, first, the buffer station 1403 is located between the transfer modules 1240 in a state that a length of the bellows 1423b is reduced. Then, the combination plate 1423c combined with the body 1423a connects to the transfer module 1240 and the combination plate 1423c and the transfer module 1240 are combined with each other using a combination member (not shown). Then, a length of the bellows 1423b is increased so that the combination plate 1423c combined with the bellows 1423b connects to the other transfer module 1240. Then, the combination plate 1423c and the other transfer module 1240 are combined with each other using a combination member (not shown).

As an alternative, unlike FIG. 7, the housing may include the bellows on both sides of the body. Also, as an alternative, an entire region of the housing may be formed as bellows.

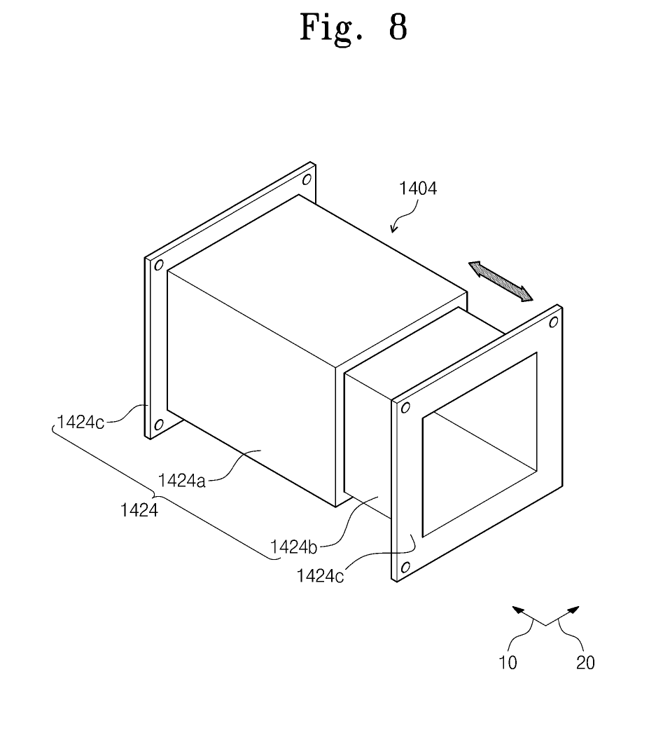

FIG. 8 is a perspective view illustrating another example of a buffer station 1404 of which a length can be changed. Referring to FIG. 8, a housing 1424 may include a first body 1424a, a second body 1424b and a combination plate 1424c. The second body 1424b is combined with the first body 1424a so that the second body 1424b protrudes from the first body 1424a or is inserted into the first body 1424a along the first direction 10. That is, a length of the housing 1424 may be changed along the first direction 10 by a telescope method. The combination plate 1424c is provided at both ends on the first and second bodies 1424a and 1424b. To combine the buffer station 1404 with the transfer modules 1240, first, the buffer station 1404 is located between the transfer modules 1240 in a state that the second body 1424b is inserted into the first body 1424a. Then, the combination plate 1424c combined with the first body 1424a is connected to the transfer module 1240 and the buffer station 1404 and the transfer module 1240 are combined with each other using a combination member (not shown). After that, the second body 1424b protrudes from the first body 1424a so that the combination member 1424c provided at the end of the second body 1424b can be connected to the other transfer module 1240, and then the buffer station 1404 and the other transfer module 1240 are combined with each other using a combination member (not shown).

In FIGS. 7 and 8, a sealing member (not shown) may be applied to a contact surface between the combination plates 1423c or 1424c and the transfer modules 1240 so that the inside of the transfer module 1240 and the inside of the housings 1423 or 1424 of the buffer stations 1403 or 1404 are sealed from the outside.

Referring back to FIG. 1, according to an embodiment, the process facilities 1200 have a same structure as each other. The transfer modules 1240 and the buffer stations 1400 connected to each other may be disposed along an imaginary line, referred to as a connection line 50. According to an embodiment, the connection line 50 is a straight line like that shown in FIG. 1. Alternatively, the connection line 50 may have various shapes such as a capital “L” or a capital “T”. According to an embodiment, the treating modules 1260 of the process facilities 1200 are sequentially and alternately disposed at a first side and a second side of the connection line 50. Guide rails 42 are provided to a first side and a second side of the connection line 50 so that the guide rails 42 face the load ports 1220 on first and second sides of the connection line 50. A return device such as an overhead transfer 40 may move along the guide rails 42. According to an embodiment, the guide rail 42 provided to the first side of the connection line 50 is independent of the guide rail provided to the second side of the connection line 50. As an alternative, the guide rail 42 provided to the first side of the connection line 50 and the guide rail 42 provided to the second side of the connection line 50 are parts of one rail.

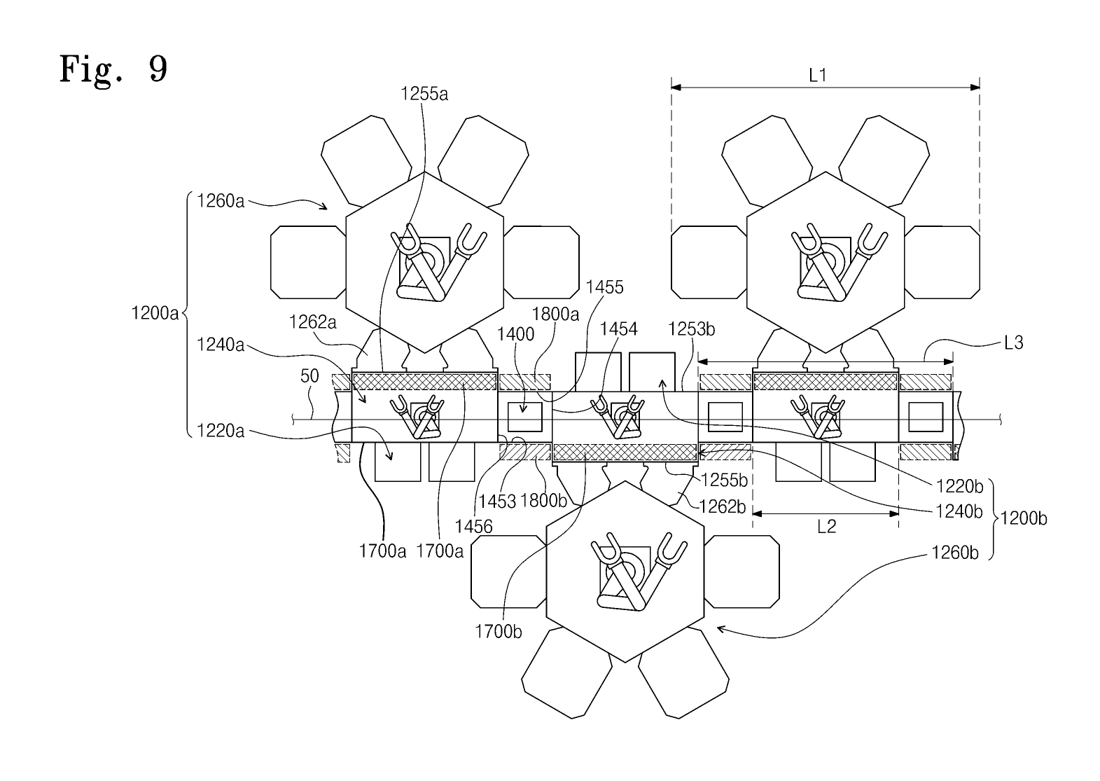

FIG. 9 is an enlarged drawing of three process facilities provided in FIG. 1 and buffer stations disposed between the process facilities.

For convenience of description, in FIG. 9, a process facility provided to a first side of the connection line 50 is called a first facility 1200a. A load port, a transfer module and a treating module that are provided to the first facility 1200a are called a first load port 1220a, a first transfer module 1240a and a first treating module 1260a, respectively. A process facility provided to a second side of the connection line 50 is called a second facility 1200b. A load port, a transfer module and a treating module that are provided to the second facility 1200b are called a second load port 1220b, a second transfer module 1240b and a second treating module 1260b, respectively.

As described above, the first treating module 1260a is combined with a third sidewall 1255a of the first transfer module 1240a and the second treating module 1260b is combined with a third sidewall 1255b of the second transfer module 1240b. The third sidewall 1255a of the first transfer module 1240a protrudes farther from the connection line 50 toward the first treating module 1260a as compared with a first sidewall 1253b of the second transfer module 1240b. The third sidewall 1255b of the second transfer module 1240b protrudes farther from the connection line 50 toward the second treating module 1260b as compared with a first sidewall 1253a of the first transfer module 1240a.

A buffer station 1400 disposed between the first transfer module 1240a and the second transfer module 1240b includes a first sidewall 1453, a second sidewall 1454, a third sidewall 1455 and a fourth sidewall 1456. The first sidewall 1453 and the third sidewall 1455 face each other. The second sidewall 1454 and the fourth sidewall 1456 face each other. The second sidewall 1454 and the fourth sidewall 1456 are combined with a first transfer module 1240a and a second transfer module 1240b, respectively. The first sidewall 1453 is disposed on a plane that extends from the first sidewall 1253a of the first transfer module 1240a. The third sidewall 1455 is disposed on a plane that extends from the first sidewall 1253b of the second transfer module 1240b.

A first service space 1880a is surrounded by a portion 1700a protruding from the first transfer module 1240a, the second load ports 1220b and a buffer station 1400. The first service space 1800a is a space in which a worker may be located when maintenance of the first transfer module 1240a, load lock chambers 1262a of the first treating module 1260a, the buffer station 1400 and the second load ports 1220b is needed. Also, a second service space 1800b is surrounded by a portion 1700b protruding from the second transfer module 1240b, the first load ports 1220a and a buffer station 1400. The second service space 1800b is a space in which a worker may be located when maintenance of the second transfer module 1240b, load lock chambers 1262b of the second treating module 1260b, the buffer station 1400 and the first load ports 1220a is needed.

According to an embodiment, the process facilities 1200a and 1200b have a same size and a same shape. The maximum width L1 parallel to the first direction 10 of the treating module 1260 may be greater than the maximum width L2 parallel to the first direction 10 of the corresponding transfer module 1240.

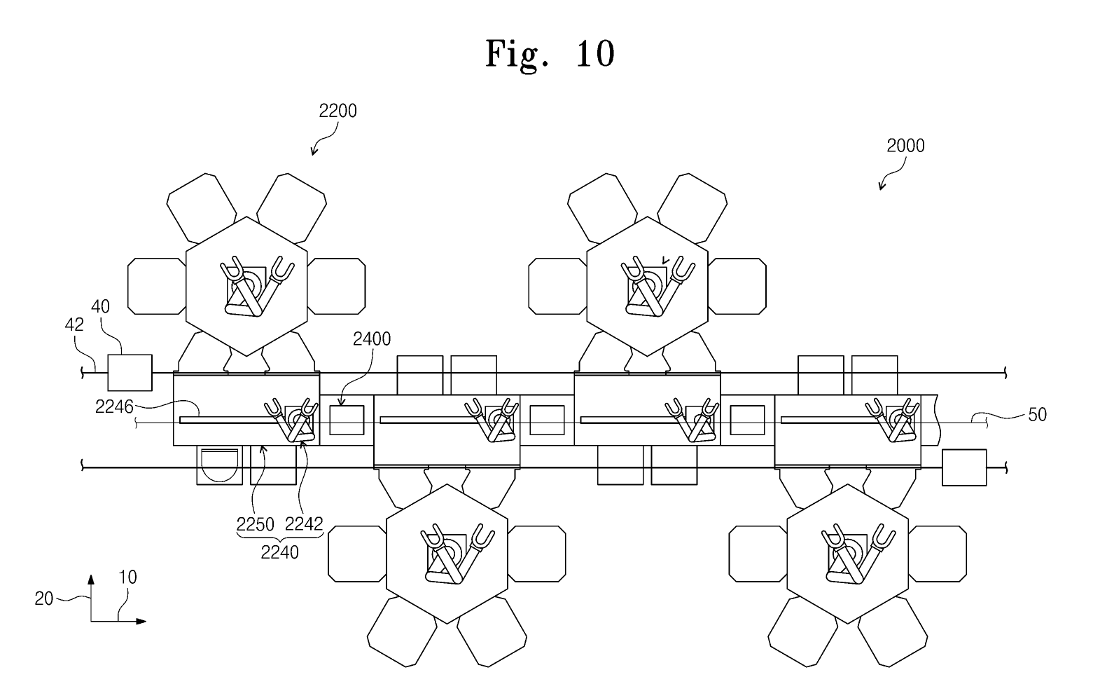

FIG. 10 is a drawing illustrating another example of a substrate treating system 2000. Referring to FIG. 10, the substrate treating system 2000 includes a process facilities 2200 including a transfer module 2240 and a buffer station 2400 provided between the adjacent transfer modules 2240. In the substrate treating system 2000 of FIG. 10, treating modules 2260 of all the process facilities 2200 are disposed on either a top side or a bottom side of the connection line 50 on which the transfer modules 2240 and the buffer stations 2400 are arranged, not on both sides of the connection line 50. In this case, with respect to the connection line 50, an overhead transfer 40 and a guide rail 42 guiding a movement of the overhead transfer 40 are provided only on the opposite side to the side on which the treating modules 2260 are provided. FIG. 10 shows treating modules 2260 on both sides of the connection line 50 for illustration purposes to show how the treating modules would look on either side of the connection line 50. However, it should be understood that the embodiment refers to all treating modules 2260 being disposed on a same side of the connection line 50.

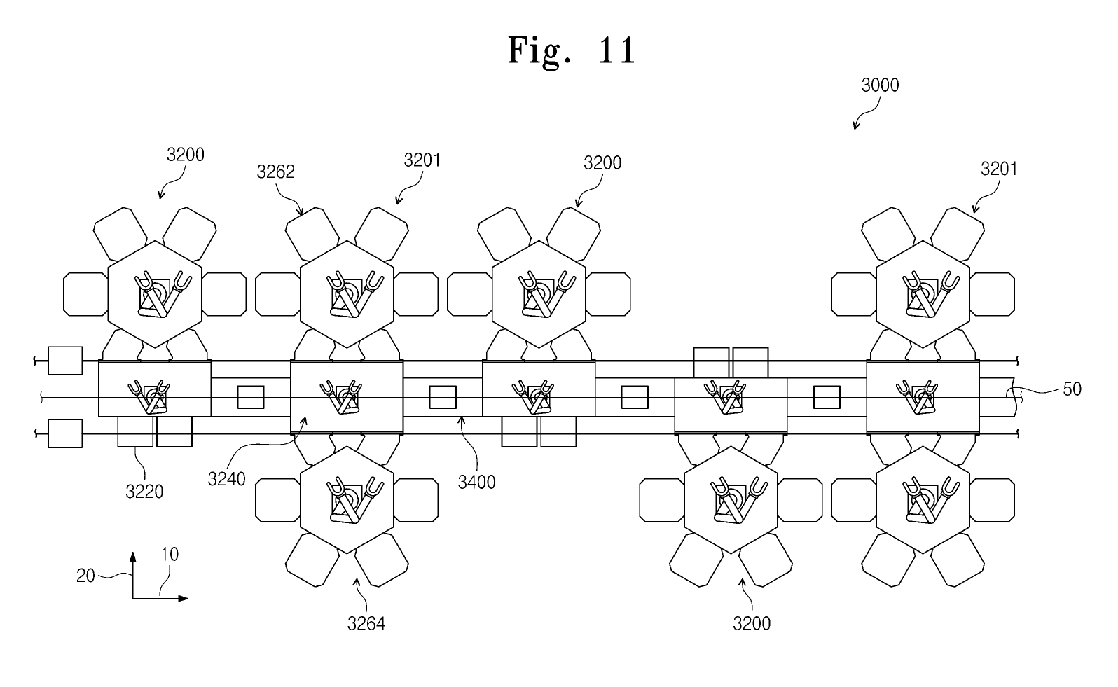

FIG. 11 is a drawing illustrating another example of a substrate treating system 3000. Referring to FIG. 11, the substrate treating system 3000 includes process facilities 3200 and 3201 including transfer modules 3240 and a buffer station 3400 provided between the adjacent transfer modules 3240. Some process facilities 3201 include two treating modules 3262 and 3264 without load ports 3220. For convenience of description, in FIG. 11, one of the two treating modules is called a first treating module 3262 and the other of the two treating modules is called a second treating module 3264. The first and second treating modules 3262 and 3264 may have a structure similar to the treating module 1260 of FIG. 1. The first and second treating modules 3262 and 3264 share a transfer module 3240. The first treating module 3262, the transfer module 3240 and the second treating module 3264 are sequentially provided in a line along the second direction 20. The first and second treating modules 3262 and 3264 are symmetrically provided with respect to the transfer module 3240. In FIG. 11, it is illustrated that the first and second treating modules 3262 and 3264 have a same structure. However, as an alternative, the first and second treating modules 3262 and 3264 may have a different structure from each other. The first and second treating modules 3262 and 3264 may perform a same process on the substrate. As an alternative, the first and second treating modules 3262 and 3264 may perform a different process from each other on the substrate.

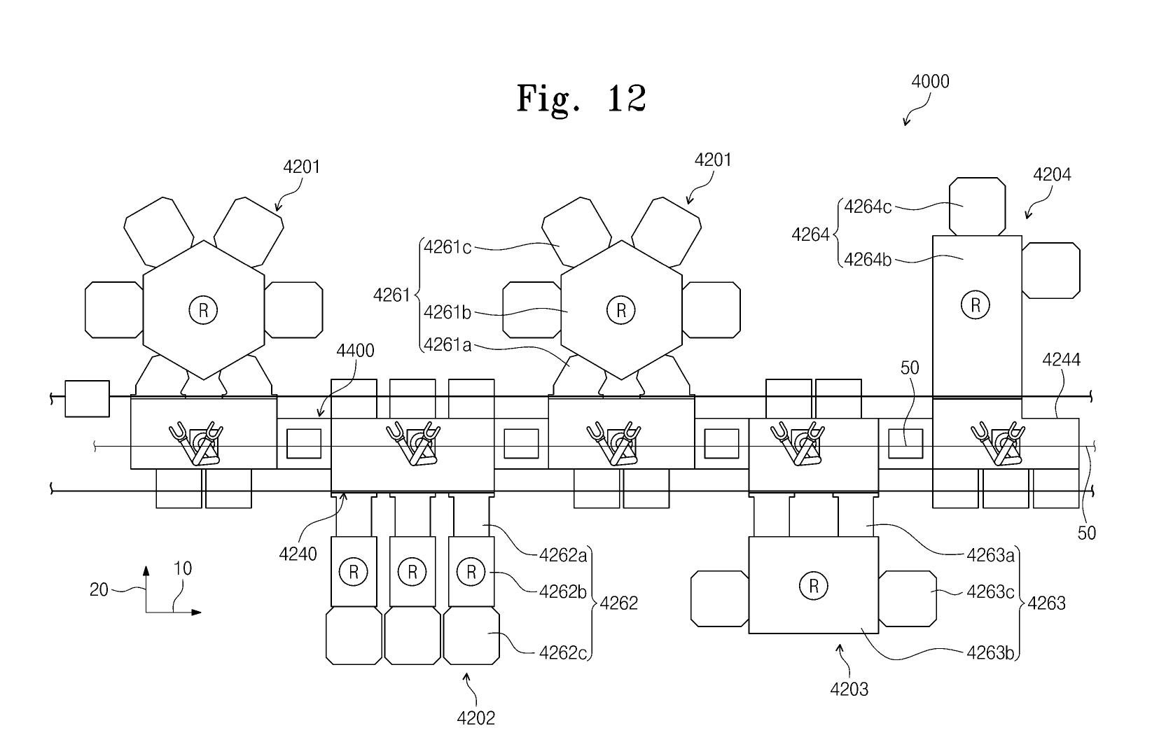

FIG. 12 is a drawing illustrating another example of a substrate treating system 4000. Referring to FIG. 12, the substrate treating system 4000 includes process facilities 4201, 4202, 4203 and 4204 including transfer modules 4240 and buffer stations 4400 provided between adjacent transfer modules 4240. Treating modules 4261, 4262, 4263 and 4264 of the process facilities 4201, 4202, 4203 and 4204 have different structures from one another. The treating module 4261 of the process facility 4201 includes load-lock chambers 4261a, a polygonal transfer chamber 426 lb and a plurality of process chambers 4261c. The treating module 4262 of the processing facility 4202 has a structure where a load-lock chamber 4262a and a process chamber 4262c are combined with a transfer chamber 4262b and the load-lock chamber 4262a, the transfer chamber 4262b and the process chamber 4262c are sequentially provided in a line along the second direction 20. The treating module 4263 of the process facility 4203 has a structure where a transfer chamber 4263b having, for example, a square or rectangular shape is combined with load-lock chambers 4263a and process chambers 4263c disposed around the transfer chamber 4263b. The treating module 4264 of the process facility 4204 has a polygonal transfer chamber 4264b and a plurality of process chambers 4264c disposed around the transfer chamber 4264b. The transfer chamber 4264b is directly combined with the transfer module 4244. The structures of the treating modules 4261, 4262, 4263 and 4264 illustrated in FIG. 12 are examples and the treating modules may have various structures.

In the case of FIG. 12, according to an embodiment, the process facilities 4201, 4202 and 4203 may perform a process on the substrate in a vacuum state and the process facility 4204 may perform a process on the substrate in an atmospheric pressure.

In FIG. 12, the treating modules 4261, 4262, 4263 and 4264 are provided on both sides of the connection line 50 on which the buffer stations 4400 and the transfer modules 4240 and 4244 are arranged. However, the treating modules 4261, 4262, 4263 and 4264 may be provided on one side of the connection line 50 as described above in connection with FIG. 10.

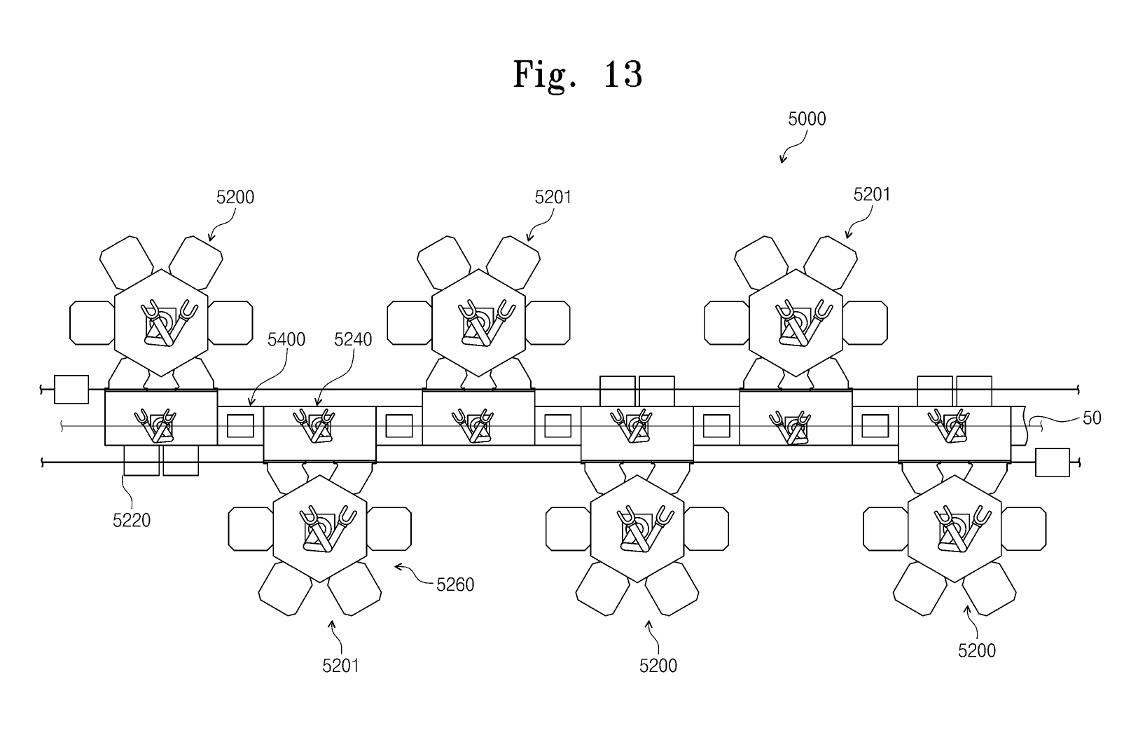

FIG. 13 is a drawing illustrating another example of a substrate treating system 5000. Referring to FIG. 13, the substrate treating system 5000 includes process facilities 5200 and 5201 including transfer modules 5240 and buffer stations 5400 provided between the adjacent transfer modules 5240. The process facilities 5201 include a transfer module 5240 and a treating module 5260 without load ports 5220.

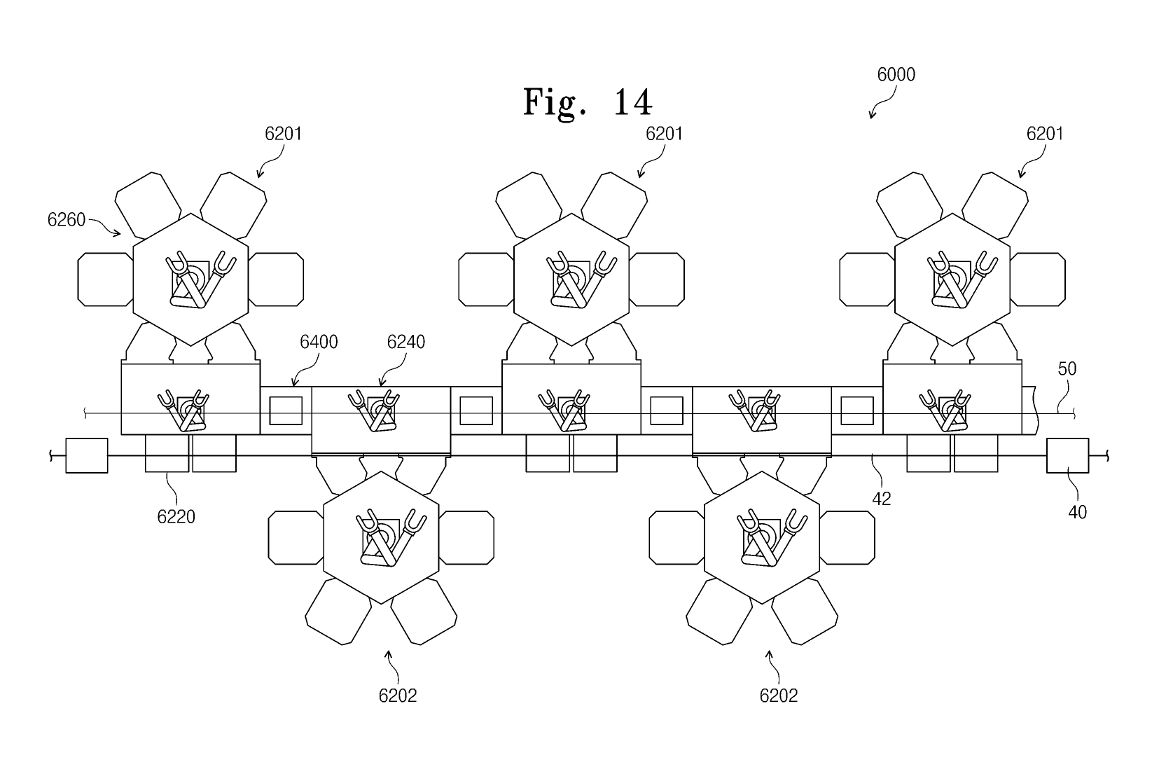

FIG. 14 is a drawing illustrating another example of a substrate treating system 6000. Referring to FIG. 14, the substrate treating system 6000 includes process facilities 6201 and 6202 including transfer modules 6240 and buffer stations 6400 provided between the adjacent transfer modules 6240. Load ports 6220 are provided to the process facilities 6201 including a treating module 6260 disposed on a first side of the connection line 50 on which the transfer modules 6240 and the buffer stations 6400 are arranged, but the load ports 6220 are not provided to the process facilities 6202 disposed on a second side of the connection line 50. In this case, an overhead transfer 40 and a guide rail 42 guiding a movement of the overhead transfer 40 are provided on only the second side of the connection line 50.

In FIGS. 13 and 14, the treating modules 5200, 5201, 6201 and 6202 have a same structure. However, according to an embodiment, the treating modules 5200, 5201, 6201 and 6202 may have different structures from one another as illustrated in FIG. 11. As an alternative, in FIG. 14, the treating modules disposed on a same side of the connection line 50 may have a same structure as each other, but different structures from the treating modules disposed on another side of the connection line 50. For example, the treating modules 6201 may have the same structure as each other, and the treating modules 6202 may have a different structure from the treating modules 6201, but the same structure as each other.

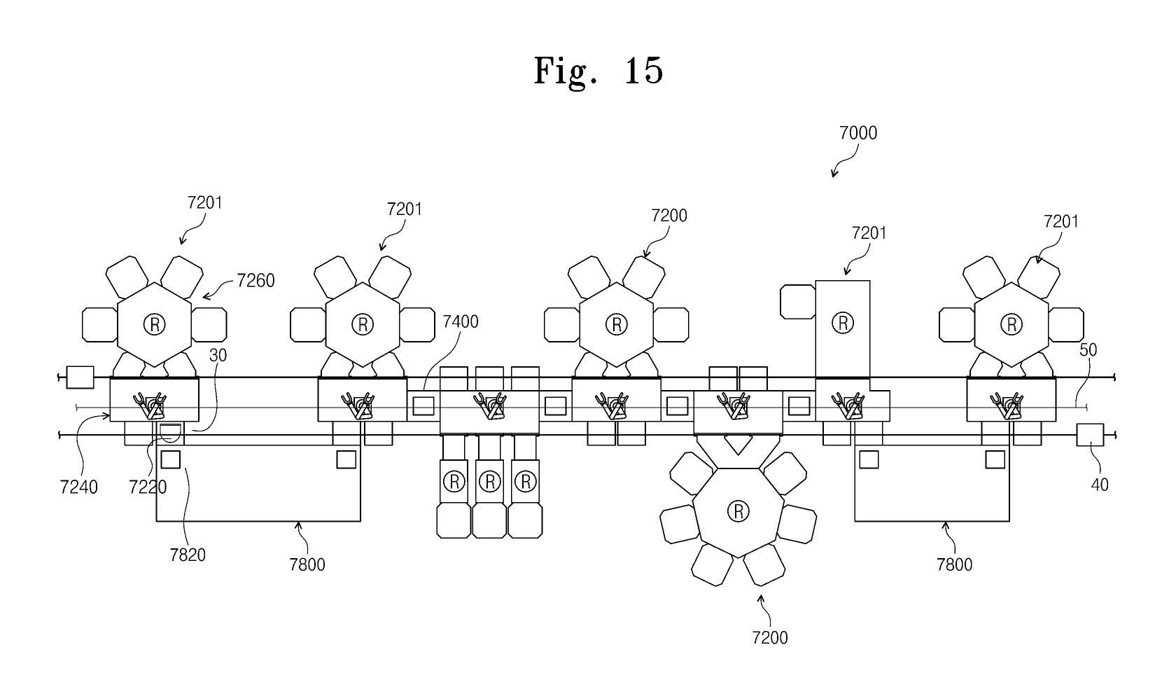

FIG. 15 is a drawing illustrating another example of a substrate treating system 7000. Referring to FIG. 15, the substrate treating system 7000 includes process facilities 7200 and 7201 including transfer modules 7240 and buffer stations 7400 provided between the adjacent transfer modules 7240. The substrate treating system 7000 further includes a process treating device 7800. The process treating device 7800 is combined with a load port 7220 of the process facilities 7201. A treating module 7260 of the process facility 7201 with which the process treating device 7800 is combined and the process treating device 7800 are located at the opposite sides with respect to the connection line 50. The process treating device 7800 is combined with load ports 7220 of two process facilities 7201 at the same time. Buffer stations 7400 are not provided between the transfer modules 7240 of the two process facilities 7201 combined with the process treating device 7800. The two process facilities 7201 are adjacent to each other.

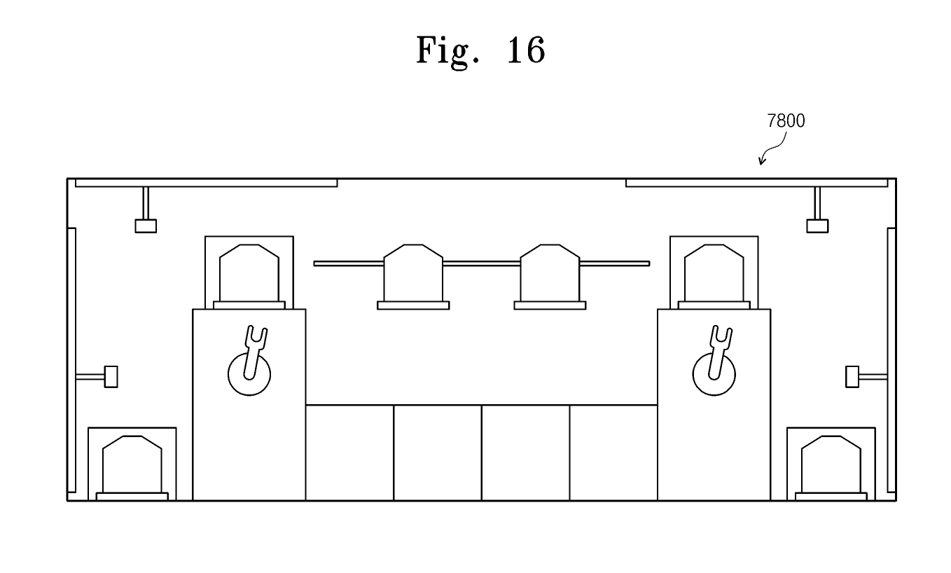

According to an embodiment, the process treating device 7800 may be a batch process device performing a process on a plurality of substrates at the same time. For example, a process performed in the process treating device 7800 may be a cleaning process or a strip process. According to an embodiment, like FIG. 16, the process treating device 7800 may be a device having a structure similar to or identical to the device disclosed in FIG. 10 of U.S. Published Patent No. 2004/0165973, which is commonly assigned to the assignee of the instant application, and is incorporated by reference herein.

A rotation member 7820 rotating a vessel 30 including a substrate according to an internal structure of the process treating device 7800 is provided in the process treating device 7800. The overhead transfer 40 puts the vessel 30 on the load port 7220 so that an opening of the vessel 30 faces the transfer module 7240. The process treating device 7800 transfers the vessel 30 to the inside of the process treating device 7800, rotates the vessel 30 180 degrees, and then unloads the substrate from the vessel 30. As an alternative, the rotation member rotating the vessel 30 may be provided on the load port 7220 or the overhead transfer 40. According to an embodiment, the vessel 30 moves to the process treating device 7800 after being placed on the load port 7220 of the process facility 7201 and moves to the load port 7220 of another process facility 7201 after a process is completed in the process treating device 7800. As an alternative, the substrate may directly be moved to the process treating device 7800 while the vessel 30 remains on the load port 7220.

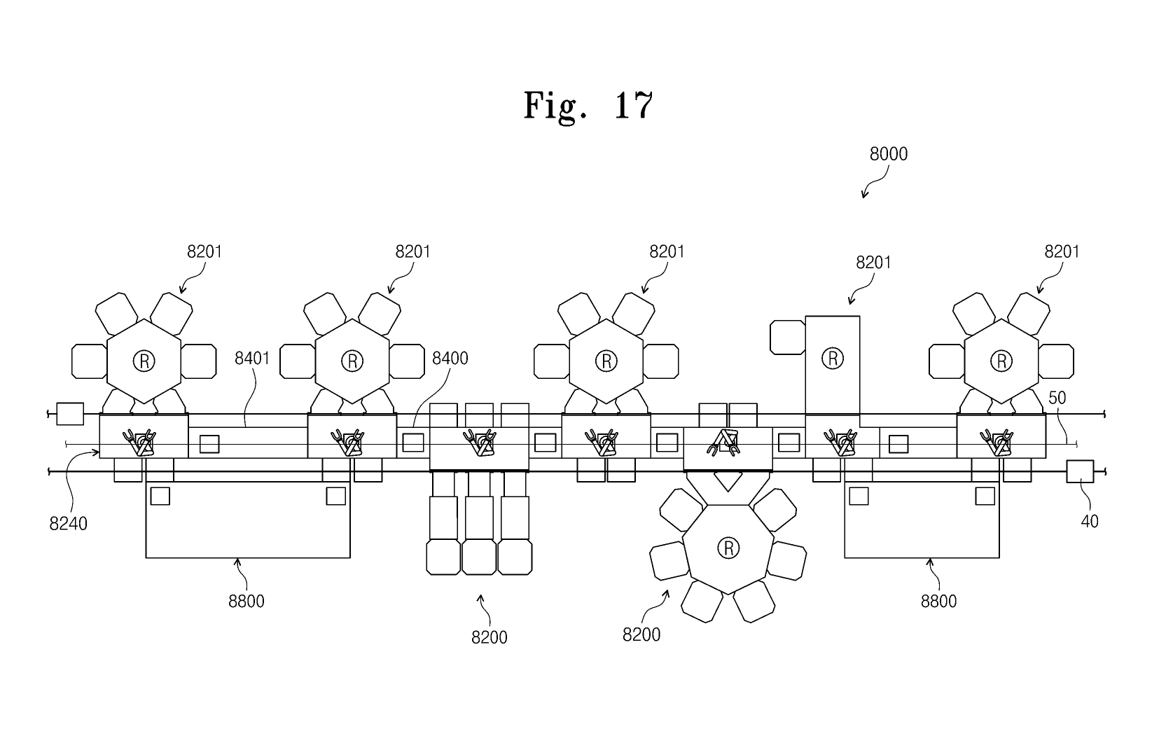

FIG. 17 is a drawing illustrating another example of a substrate treating system 8000. The substrate treating system 8000 of FIG. 17 includes process facilities 8200 and 8201 including transfer modules 8240, buffer stations 8400, 8401 provided between adjacent transfer modules 8240 and process treating devices 8800, similar to the substrate treating system 7000 of FIG. 15. In the substrate treating system 8000, the buffer station 8401 is provided between the transfer modules 8240 of the process facilities 8201 with which the process treating device 8800 is combined. According to an embodiment, the buffer station 8401 has a structure similar to the buffer station 1401, 1402 of FIG. 5 or 6.

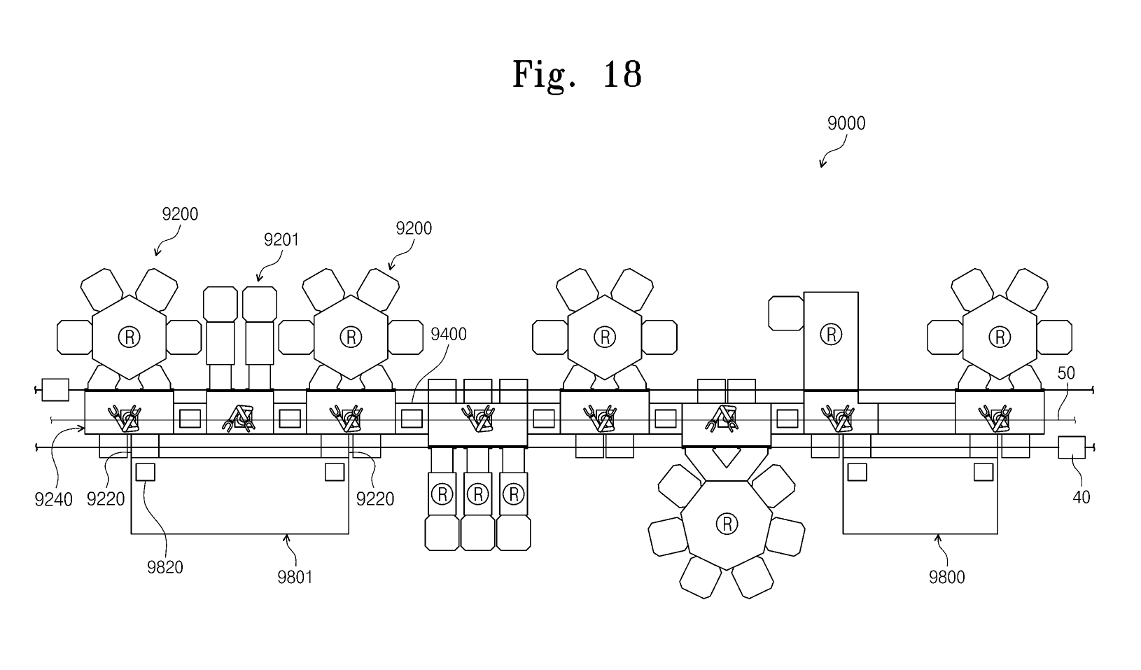

FIG. 18 is a drawing illustrating another example of a substrate treating system 9000. The substrate treating system 9000 includes process facilities 9200 and 9201 including transfer modules 9240, buffer stations 9400 provided between adjacent transfer modules 9240 and process treating devices 9800, 9801, similar to the substrate treating system 7000 of FIG. 15. In the substrate treating system 9000, the process treating device 9801 is combined with load ports 9220 of the process facilities 9200 between which the process facility 9201 is disposed.

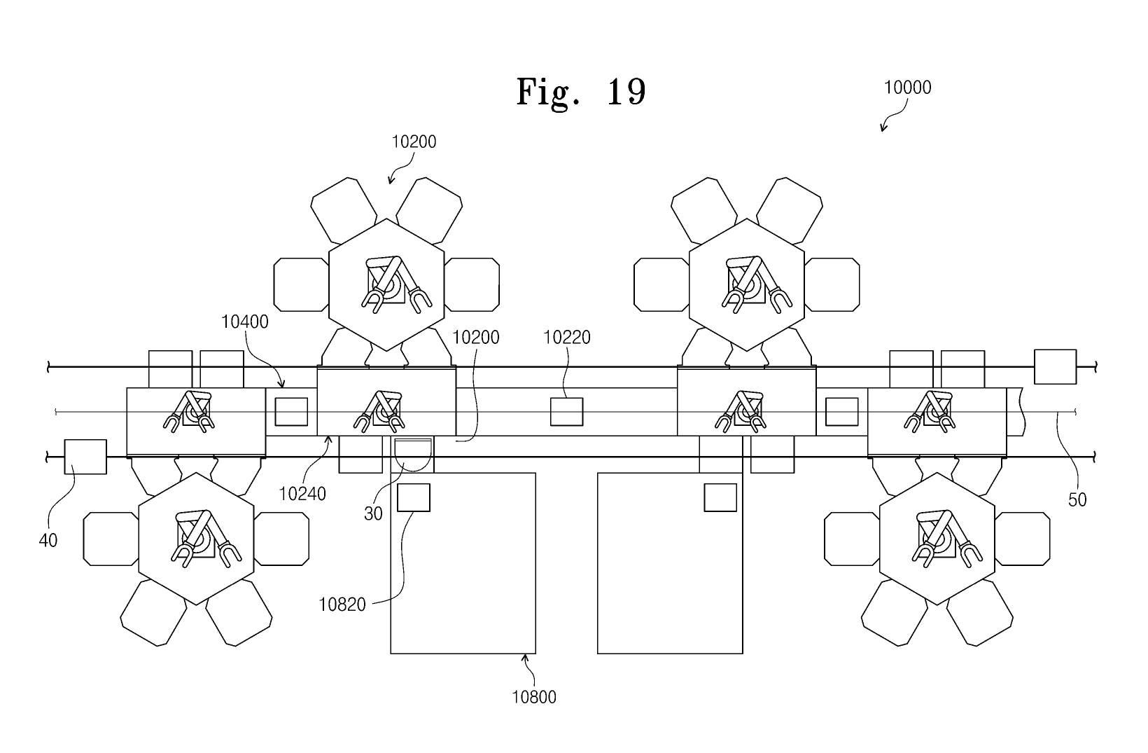

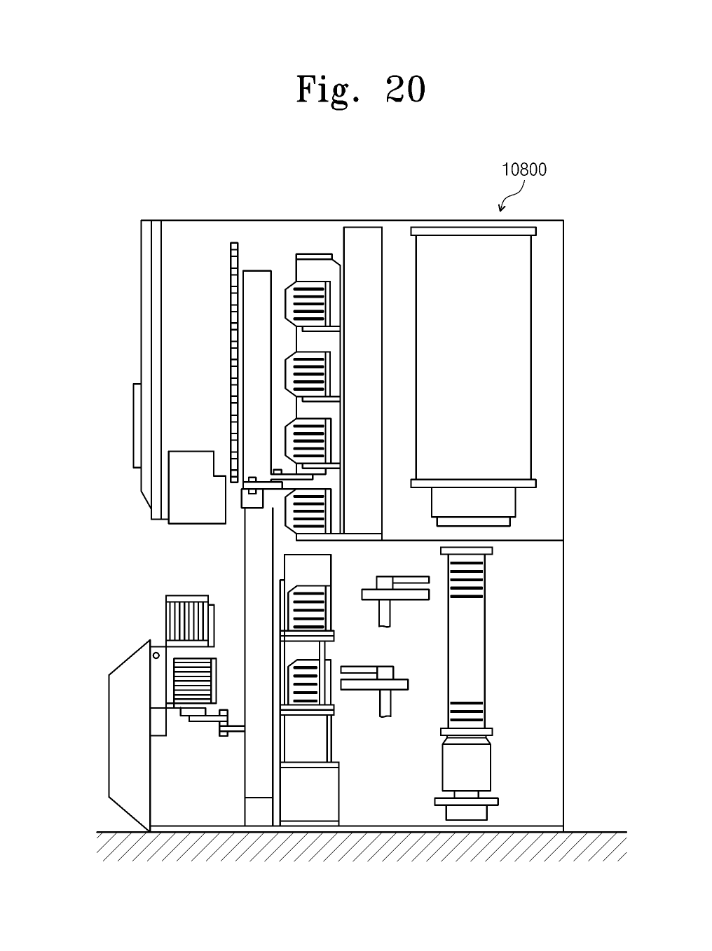

FIG. 19 is a drawing illustrating another example of a substrate treating system 10000. The substrate treating system 10000 includes process facilities 10200 including transfer modules 10240, buffer stations 10400 provided between adjacent transfer modules 10240 and process treating devices 10800, similar to the substrate treating system 7000 of FIG. 15. In the substrate treating system 10000, the process treating device 10800 is combined with a load port 10220 of one process facility 10200. The process treating device 10800 may be, for example, a device performing a diffusion process. For example, the processing treating device 10800, like that shown in FIG. 20, may be a device having a structure similar to or identical to the device disclosed in FIG. 4 of U.S. Published Patent No. 2008/0255697, which is commonly assigned to the assignee of the instant application, and is incorporated herein by reference.

A rotation member 10820 rotating a vessel 30 including a substrate according to an internal structure of the process treating device 10800 is provided in the process treating device 10800. The rotation member 10820 rotates the vessel 30 so that an opening direction of the vessel 30 rotates 180 degrees. As an alternative, the rotation member may be provided at a load port 10200 or an overhead transfer 40.

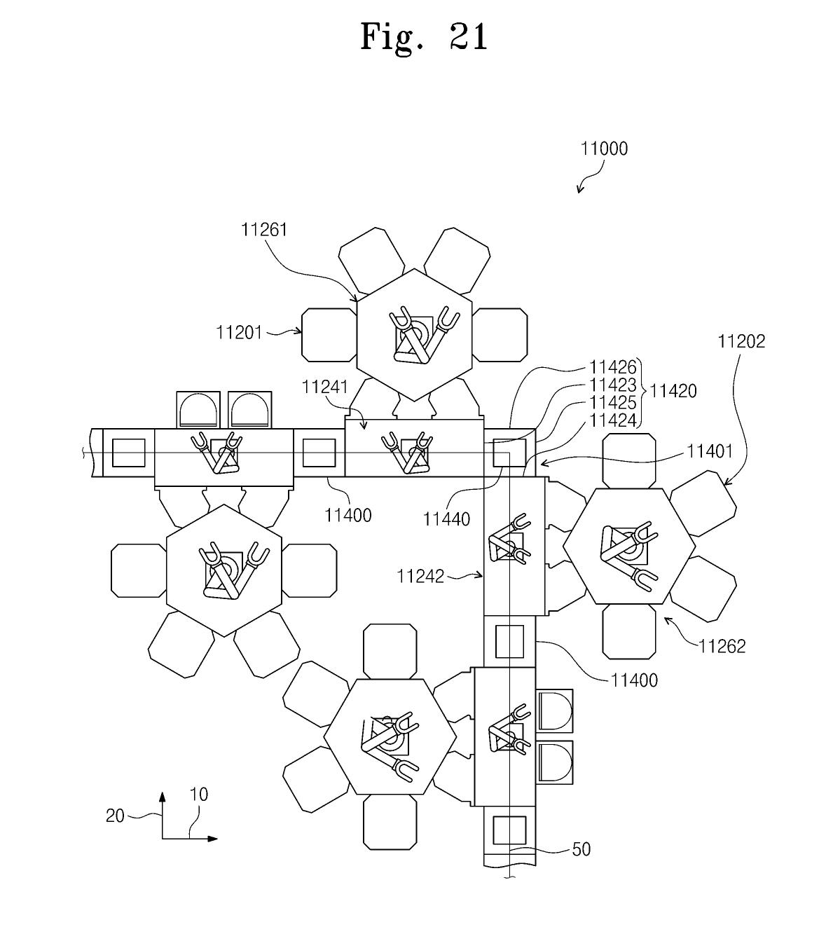

FIG. 21 is a drawing illustrating another example of a substrate treating system 11000. The substrate treating system 11000 includes process facilities 11201 and 11202 including transfer modules 11241 and 11242 and buffer stations 11400 and 11401 provided between adjacent transfer modules 11241 and 11242. The transfer modules 11241 and 11242 and the buffer station 11401 in the substrate treating system 11000 have different combination structures from the transfer module 1240 and the buffer station 1400 of FIG. 1.

The process facilities 11201 and 11202 include the transfer modules 11241 and 11242 and treating modules 11261 and 11262, respectively. In the process facility 11201, the transfer module 11241 and the treating module 11261 are provided along the second direction 20 with respect to each other. In another process facility 11202, the transfer module 11242 and the treating module 11262 are provided along the first direction 10 with respect to each other. For convenience for description, in FIG. 21, the transfer module 11241 is called a first transfer module and the transfer module 11242 is called a second transfer module.

According to an embodiment, the buffer station 11401 includes a housing 11420 and a buffer member 11440. According to an embodiment, the buffer member 11440 has a structure similar to or identical to the buffer member 1440 of FIG. 2 and FIG. 3. The housing 11420 includes a top surface (not shown), a bottom surface (not shown), a first side 11423, a second side 11424, a third side 11425 and a fourth side 11426. According to an embodiment, the housing 11420 has a rectangular shape or a regular hexahedron shape. The first and third sides 11423 and 11425 face each other and the second and fourth sides 11424 and 11426 face each other. The first side 11423 is perpendicular to the second side 11424. Openings (not shown) through which the substrate passes and doors (not shown) opening and closing the openings are provided at the first side 11423 and the second side 11424. The first transfer module 11241 is combined with the first side 11423 and the second transfer module 11242 is combined with the second side 11424. A transfer of the substrate between the first transfer module 11241 and the second transfer module 11242 is done through the buffer station 11401 disposed between the first and second transfer modules 11241 and 11242.

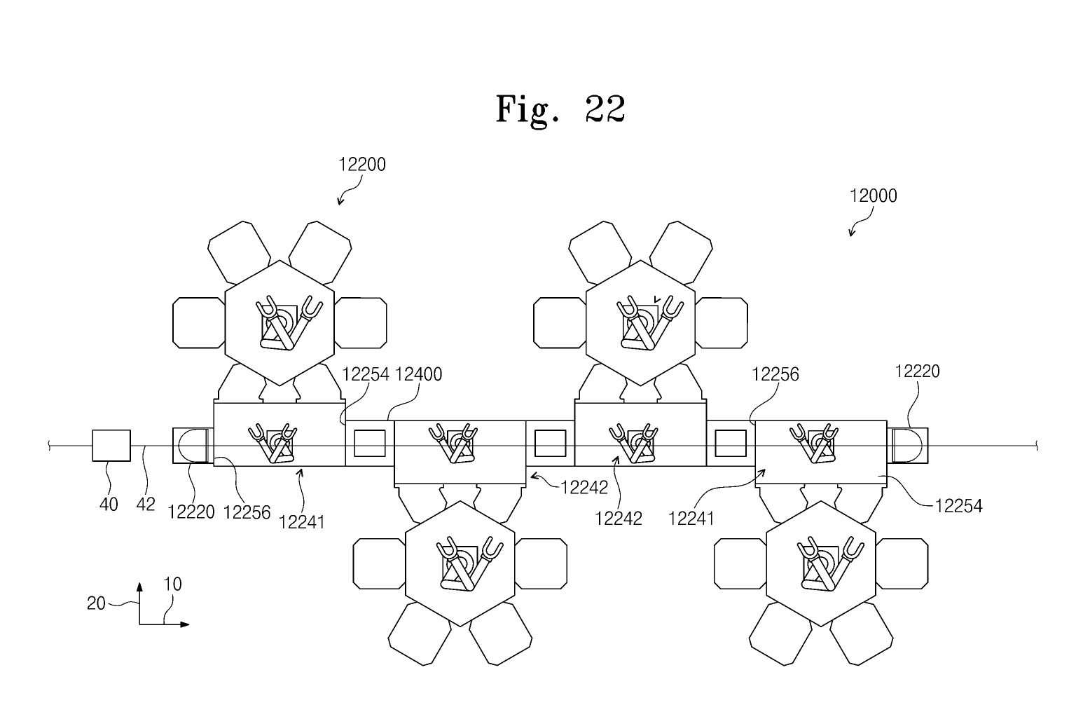

FIG. 22 is a drawing illustrating another example of a substrate treating system 12000. Referring to FIG. 22, the substrate treating system 12000 includes process facilities 12200 including transfer modules 12241, 12242, and buffer stations 12400 provided between adjacent transfer modules 12241 and 12242, similar to the substrate treating system 1000 of FIG. 1. A load port 12220 is combined with a second sidewall 12254 or a fourth sidewall 12256 of the end transfer modules 12241, the transfer modules 12241 and 12242 being provided along the connection line. Thus, the load ports 12220 are each provided at ends of the substrate treating system 12000, and the transfer modules 12241 and 12242 and the buffer stations 12400 are sequentially and alternately provided between the load ports 12220. A guide rail 42 passing an upper portion of the load port 12220 to face the load ports 12220 is provided and a return device returning a vessel, such as an overhead transfer 40, moves along the guide rail 42. Although the connection line is not illustrated in FIG. 22, according to an embodiment, the connection line overlaps the guide rail 42.

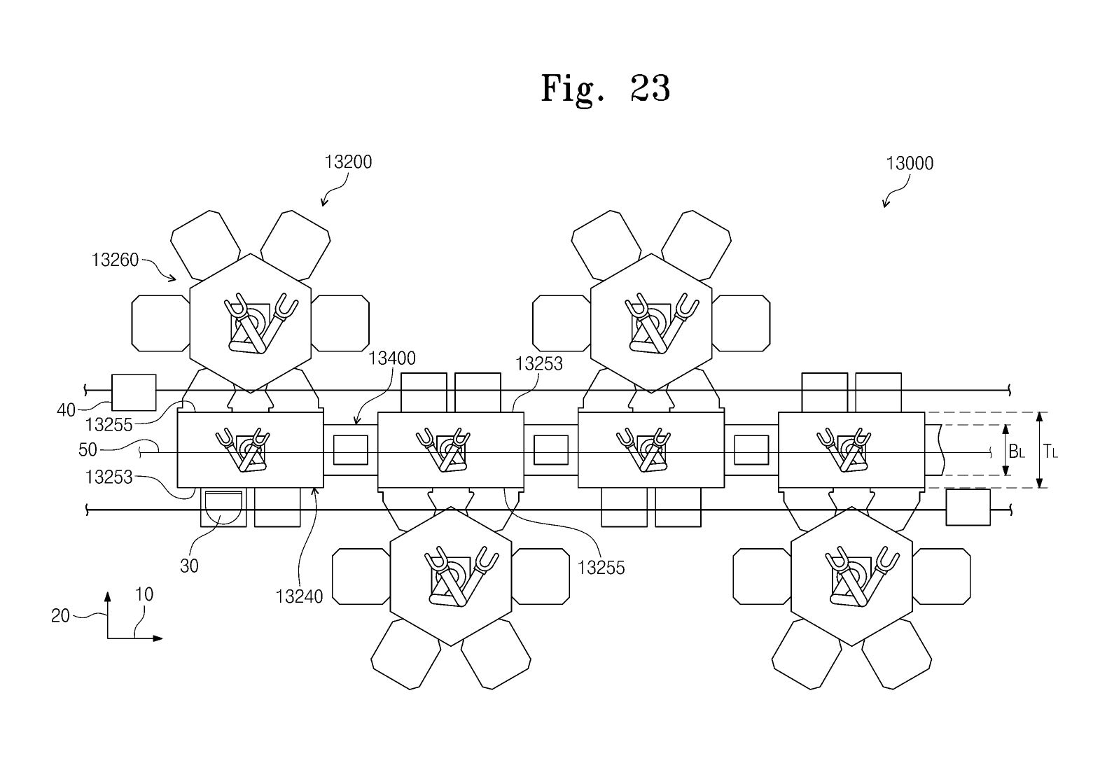

FIG. 23 is a drawing illustrating another example of a substrate treating system 13000. Referring to FIG. 23, the substrate treating system 13000 includes process facilities 13200 including a transfer module 13240, and buffer stations 13400 provided between adjacent transfer modules 13240, similar to the substrate treating system 1000 of FIG. 1. Also, treating modules 13260 are alternately disposed on a first side and a second side of the connection line 50. A first sidewall 13253 of one of the adjacent transfer modules 13240 and a third sidewall 13255 of the other of the adjacent transfer modules 13240 may be located at an equal distance from the connection line 50. Also, each of the transfer modules 13240 and the buffer stations 13400 may be located at an equal distance from the connection line 50.

In the substrate treating systems described above, it is described that all the process facilities are connected to one another through the buffer stations or the substrate treating devices. According to an embodiment, the process facilities may be organized into groups, and process facilities that belong to a group are connected to one another through the buffer stations.

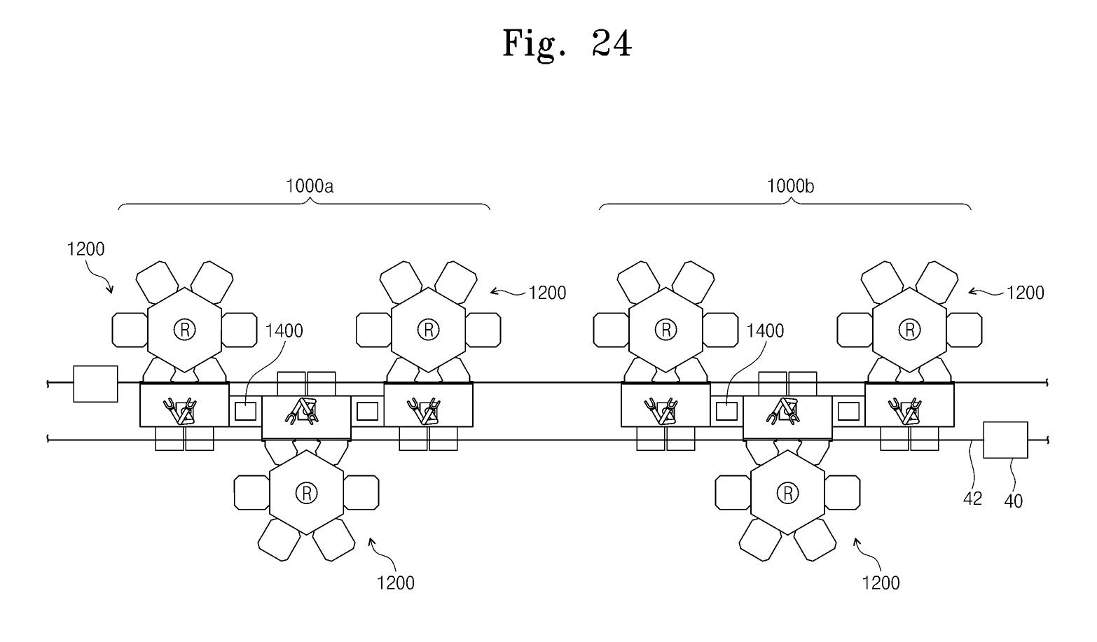

For example, according to an embodiment, as illustrated in FIG. 24, process facilities 1200 may be grouped into a first group 1000a, and a second group 1000b. Process facilities 1200 belonging to the first group 1000a are connected to one another through the buffer stations 1400 and process facilities 1200 belonging to the second group 1000b are connected to one another through the buffer stations 1400. A vessel including substrates may be transferred between the process facilities 1200 belonging to the first group 1000a, between the process facilities 1200 belonging to the second group 1000b and between the process facilities 1200 of the first group 1000a and the process facilities 1200 of the second group 1000b by a return device such as an overhead transfer, an automatic guided vehicle and a rail guided vehicle, or a worker.

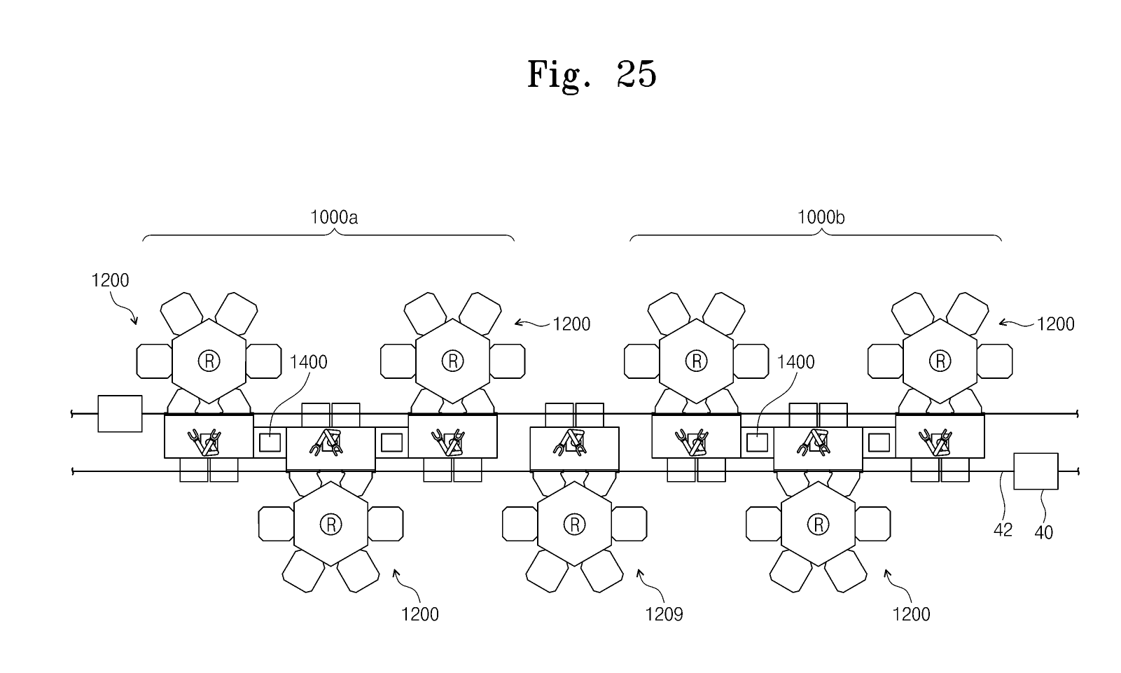

As illustrated in FIG. 25, one or a plurality of process facilities 1209 to which a buffer station is not connected may be independently provided between the first group 1000a and the second group 1000b.

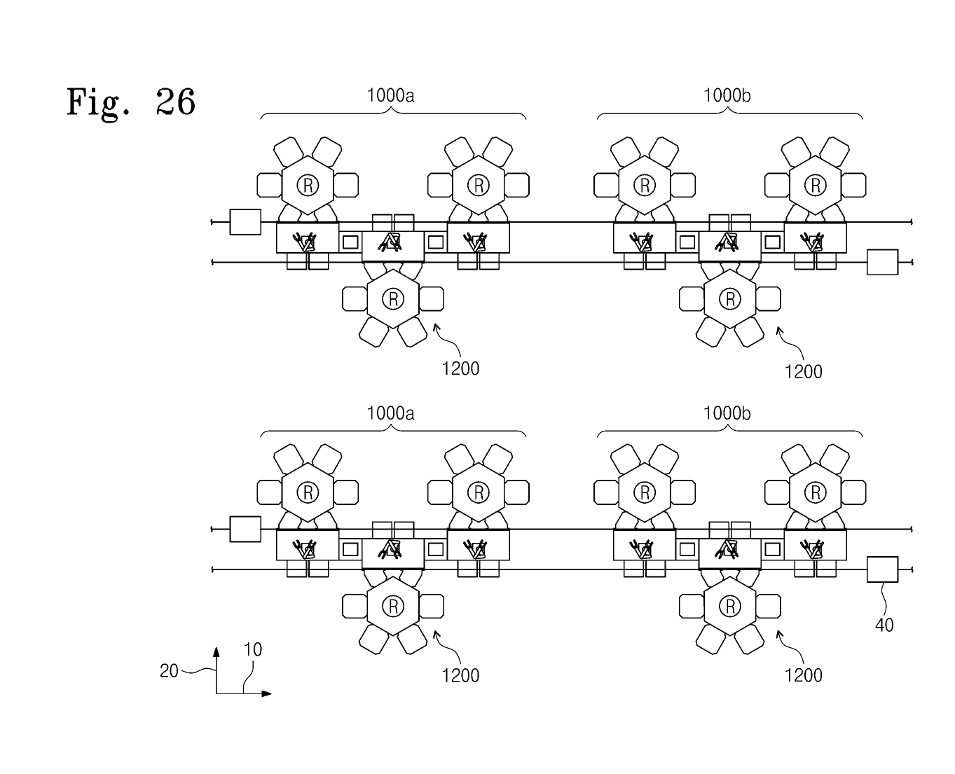

As illustrated in FIG. 26, a plurality of substrate treating systems, such as, for example, those of FIG. 1 or FIG. 24, may be provided. The substrate treating systems may be parallel to one another and may be separated from each other along a second direction.

Although a substrate treating system having the same structure as the embodiment of FIG. 1 is illustrated in FIGS. 24 through 26, substrate treating systems illustrated other embodiments may be disposed in groups and/or with other substrate systems, like what is shown in FIGS. 24 through 26.

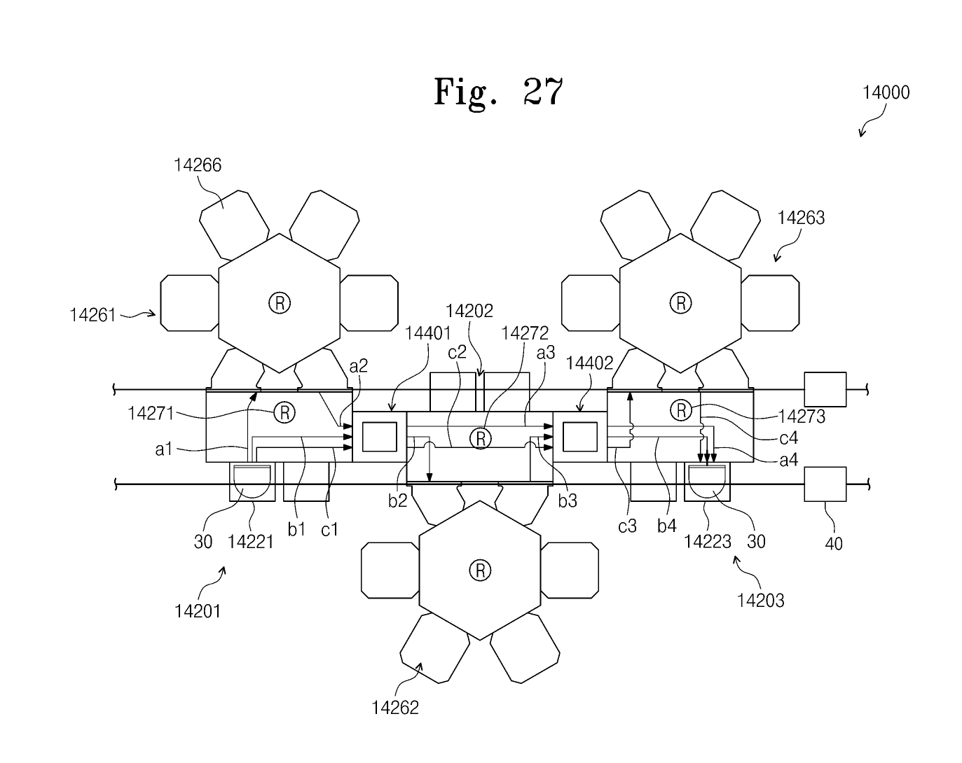

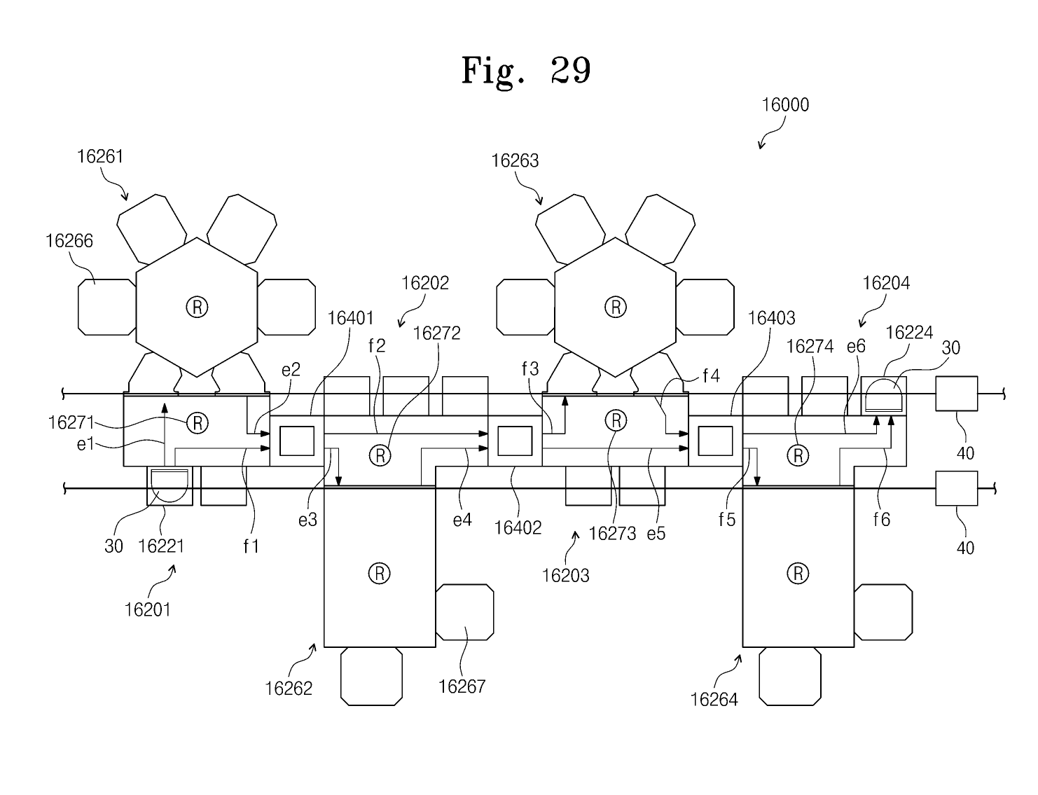

Referring to FIGS. 27 through 29, examples of methods of performing a process on substrates using a substrate treating system including a buffer station are described. For convenience of description, process facilities illustrated in FIGS. 27 through 29 are sequentially called first process facilities 14201, 15201 and 16201, second process facilities 14202, 15202 and 16202 and third process facilities 14203, 15203 and 16203, respectively from left to right. Also, a transfer robot provided to a transfer module of the first process facility 14201, 15201 and 16201 and a treating module of the first process facility 14201, 15201 and 16201 are called first transfer robots 14271, 15271 and 16271 and first treating modules 14261, 15261 and 16261, respectively. A transfer robot provided to a transfer module of the second process facility 14202, 15202 and 16202 and a treating module of the second process facility 14202, 15202 and 16202 are called second transfer robots 14272, 15272 and 16272 and second treating modules 14262, 15262 and 16262, respectively. A transfer robot provided to a transfer module of the third process facility 14203, 15203 and 16203 and a treating module of the third process facility 14203, 15203 and 16203 are called third transfer robots 14273, 15273 and 16273 and third treating modules 14263, 15263 and 16263, respectively. Also, buffer stations illustrated in FIGS. 27-29 are sequentially called first buffer stations 14401, 15401 and 16401 and second buffer stations 14402, 15402 and 16402, respectively from left to right. In FIG. 29, an additional process facility illustrated at the farthest right portion of the page is called a fourth process facility 16204. A transfer robot provided to the fourth process facility 16204 and a treating module of the fourth process facility 16204 are called a fourth transfer robot 16274 and a fourth treating module 16264, respectively. A buffer station illustrated at the farthest right portion of the page is called a third buffer station 16403.

A case that twenty five substrates are put in a vessel 30 is described as an example, but the number of substrates can be more or less than 25. The twenty five substrates put in the vessel 30 are sequentially called a first substrate, a second substrate, . . . , a twenty-fifth substrate.

FIG. 27 illustrates a route of the substrates in the substrate treating system 14000, wherein the process facilities 14201, 14202 and 14203 performing a same process are connected to one another through the buffer stations 14401 and 14402. Four process chambers 14266 are provided to each of the first process facility 14201, the second process facility 14202 and the third process facility 14203 and a same process is performed in each of the four process chambers 14266. Thus, twelve process chambers 14266 performing a same process are provided in the substrate treating system 14000. According to an embodiment, among the twenty five substrates, a process for the first through fourth substrates, the thirteenth through sixteenth substrates and the 25th substrate is performed in the first treating module 14261. A process for the fifth through eighth substrates and the seventeenth through twentieth substrates is performed in the second treating module 14262 and a process for the ninth through twelfth substrates and the 21st through 24th substrates is performed in the third treating module 14263. In FIGS. 27, a1, a2, a3 and a4 sequentially represent a route of the substrates for which a process is performed in the first treating module 14261, b1, b2, b3 and b4 sequentially represent a route of the substrates for which a process is performed in the second treating module 14262 and c1, c2, c3 and c4 sequentially represent a route of the substrates for which a process is performed in the third treating module 14263.

The vessel 30 including the substrates is placed on a load port 14221 of the first process facility 14201 by the overhead transfer 40.

The first transfer robot 14271 transfers the substrates for which a process will be performed in the first treating module 14261 from the vessel 30 to the first treating module 14261 and transfers the substrates for which a process will be performed in the second treating module 14262 and the third treating module 14263 from the vessel 30 to the first buffer station 14401. Also, the first transfer robot 14271 transfers the substrates for which a process was completed in the first treating module 14261 to the first buffer station 14401.

If all the substrates are taken out of the vessel 30, according to an embodiment, the vessel 30 is transferred to a load port 14223 of the third process facility 14203.

The second transfer robot 14272 transfers the substrates for which a process will be performed in the second treating module 14262 from the first buffer station 14401 to the second treating module 14262 and the substrates for which a process will be performed in the third treating module 14263 from the first buffer station 14401 to the second buffer station 14402. Also, the second transfer robot 14272 transfers the substrates for which a process was completed in the first treating module 14261 from the first buffer station 14401 to the second buffer station 14402 and the substrates for which a process was completed in the second treating module 14262 from the second treating module 14262 to the second buffer station 14402.

The third transfer robot 14273 transfers the substrates for which a process will be performed in the third treating module 14263 from the second buffer station 14402 to the third treating module 14263. Also, the third transfer robot 14273 transfers the substrates for which a process was completed in the first treating module 14261 and the second treating module 14262 from the second buffer station 14402 to the vessel 30 placed on the load port 14223 of the third process facility 14203. The third transfer robot 14273 transfers the substrates for which a process was completed in the third treating module 14263 from the third treating module 14263 to the vessel 30 placed on the load port 14223 of the third process facility 14203.

When the substrates are transferred from the vessel 30 to the first buffer station 14401, from the first buffer station 14401 to the second buffer station 14402 and from the second buffer station 14402 to the vessel 30, each of the first, second and third robots 14271, 14272 and 14273 may transfer a plurality of the substrates at the same time.

According to the method of treating the substrate of FIG. 27, since in the plurality of process facilities 14201, 14202 and 14203, processes can be performed on the substrates assigned to each of the process facilities 14201, 14202 and 14203 at the same time, the time required to perform a process on all of the substrates provided to the vessel 30 can be reduced.

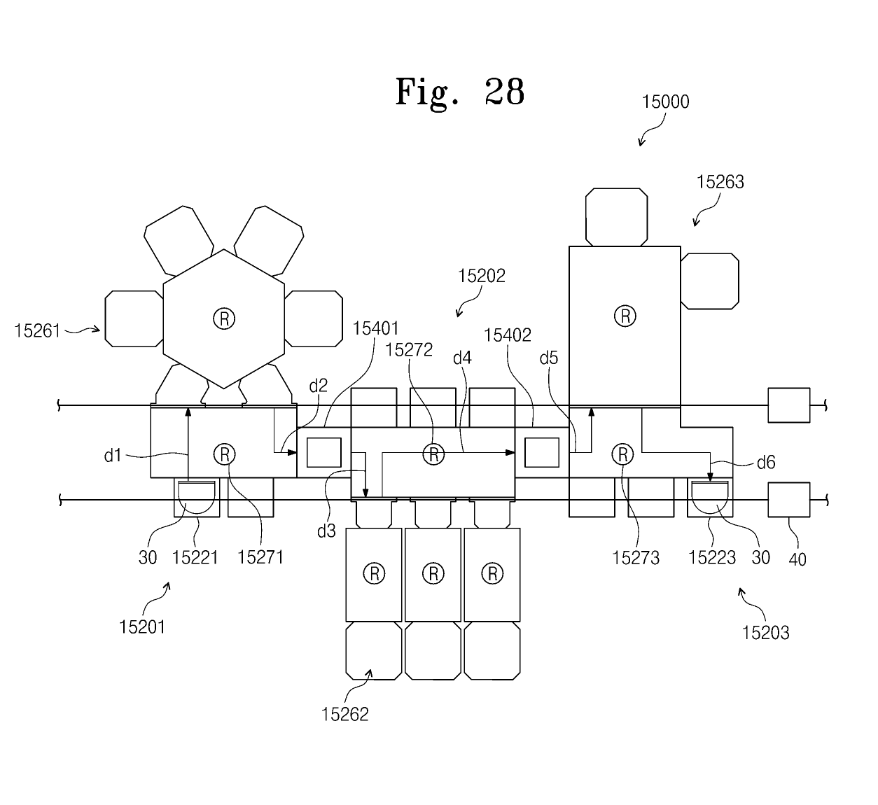

FIG. 28 illustrates a route of the substrates in the substrate treating system 15000. The process facilities 15201, 15202 and 15203 each performing a different process, and are connected to one another through the buffer stations 15401 and 15402.

The first process facility 15201, the second process facility 15202 and the third process facility 15203 sequentially perform processes on a substrate. In FIG. 28, d1, d2, d3, d4, d5 and d6 sequentially represent a route of the substrates. In the substrate treating system 15000 of FIG. 28, a process is sequentially performed on the substrates provided to the vessel 30 in a first treating module 15261, a second treating module 15262 and a third treating module 15263.

First, the vessel 30 including the substrates is placed on a load port 15221 of the first process facility 15201 by the overhead transfer 40.

A first transfer robot 15271 transfers the substrates from the vessel 30 to the first treating module 15261. According to an embodiment, if all the substrates in the vessel 30 are transferred to the first treating module 15261, the vessel 30 is transferred to a load port 15223 of the third process facility 15203 by the overhead transfer 40. The substrates for which a process is completed in the first treating module 15261 are first transferred to the first buffer station 15401 by the first transfer robot 15271. A second transfer robot 15272 transfers the substrates in the first buffer station 15401 to the second treating module 15262. The substrates for which a process is completed in the second treating module 15262 are transferred to the second buffer station 15402. A third transfer robot 15273 transfers the substrates in the second buffer station 15402 to the third treating module 15263. The substrates for which a process is completed in the third treating module 15263 are transferred to the vessel 30. According to an embodiment, some of the substrates may move through the system 15000 faster than other substrates. Accordingly, processing on some of the substrates may be completed before processing on other substrates.

According to the method of treating the substrates of FIG. 28, since the substrates can be moved independent of each other between the process facilities 15201, 15202 and 15203 using the buffer stations 15401 and 15402, another process can be performed on a substrate without waiting until a specific process is completed on all of the other substrates in the vessel 30. Also, since the substrates can be independently transferred to the process facilities 15201, 15202 and 15203 through the buffer stations 15401 and 15402, the time required to transfer the substrates may be reduced compared with when the substrates are transferred between the process facilities 15201, 15202 and 15203 using the overhead transfer 40.

FIG. 29 illustrates a route of the substrates in the substrate treating system 16000. The process facilities 16201, 16202, 16203 and 16204 either perform same processes or different processes from each other and are connected to one another through the buffer stations 16401, 16402 and 16403. For example, according to an embodiment, the first and third process facilities 16201 and 16203 perform a same process on the substrates as each other. The second and fourth process facilities 16202 and 16204 perform a different process than the first and third process facilities, and a same process on the substrates as each other. Also, according to an embodiment, the second process facility 16202 performs a process on the substrates that is a subsequent process with respect to the process performed in the first process facility 16201.

Four process chambers 16266 are provided to each of the first process facility 16201 and the third process facility 16203. Two process chambers 16267 are provided to each of the second process facility 16202 and the fourth process facility 16204. According to an embodiment, a time required to perform a process on one substrate in the process chamber 16267 of the second process facility 16202 may be less than a time required to perform a process on one substrate in the process chamber 16266 of the first process facility 16201.

Among the twenty five substrates, a process for the first through fourth substrates, the ninth through twelfth substrates, the seventeenth through 20th substrates and the 25th substrate is sequentially performed in the first treating module 16261 and the second treating module 16262. A process for the fifth through eighth substrates, the thirteenth through sixteenth substrates and the 21st through 24th substrates is sequentially performed in the third treating module 14263 and the fourth treating module 16264. In FIG. 29, e1, e2, e3, e4, e5 and e6 sequentially represent a route of the substrates for which a process is performed in the first treating module 16261 and the second treating module 16262 and f1, f2, f3, f4, f5 and f6 sequentially represent a route of the substrates for which a process is performed in the third treating module 16263 and the fourth treating module 16264.

The vessel 30 including the substrates is placed on a load port 16221 of the first process facility 16201 by the overhead transfer 40.

The first transfer robot 16271 transfers the substrates for which a process will be performed in the first treating module 16261 and the second treating module 16262 from the vessel 30 to the first treating module 16261 and transfers the substrates for which a process will be performed in the third treating module 16263 and the fourth treating module 16264 from the vessel 30 to the first buffer station 16401. Also, the first transfer robot 16271 transfers the substrates for which a process was completed in the first treating module 16261 to the first buffer station 16401.

According to an embodiment, if all the substrates are taken out of the vessel 30, the vessel 30 is transferred to a load port 16224 of the fourth process facility 16204.

The second transfer robot 16272 transfers the substrates for which a process will be performed in the third treating module 16263 and the fourth treating module 16264 from the first buffer station 16401 to the second buffer station 16402. Also, the second transfer robot 16272 transfers the substrates for which a process was completed in the first treating module 16261 from the first buffer station 16401 to the second treating module 16262 and the substrates for which a process was completed in the second treating module 16262 from the second treating module 16262 to the third buffer station 16403.

The third transfer robot 16273 transfers the substrates for which a process will be performed in the third treating module 16263 and the fourth treating module 16264 from the second buffer station 16402 to the third treating module 16263. Also, the third transfer robot 16273 transfers the substrates for which a process was completed in the second treating module 16262 from the second buffer station 16402 to the third buffer station 16403. The third transfer robot 16273 transfers the substrates for which a process was completed in the third treating module 16263 to the third buffer station 16403.

The fourth transfer robot 16274 transfers the substrates for which a process was completed in the third treating module 16263 from the third buffer station 16403 to the fourth treating module 16264. Also, the fourth transfer robot 16274 transfers the substrates for which a process was completed in the fourth treating module 16264 from the fourth treating module 16264 to the vessel 30 placed on the load port 16224 of the fourth process facility 16204. The fourth transfer robot 16274 transfers the substrates for which a process was completed in the second treating module 16262 from the third buffer station 16403 to the vessel 30 placed on the load port 16224 of the fourth process facility 16204.

According to the embodiments of the present inventive concept, a substrate transfer between process facilities may be effectively performed.

According to the embodiments of the present inventive concept, a limited space of clean room in which a plurality of process facilities is installed may be effectively used.

Although exemplary embodiments of the present inventive concept have been described hereinabove, it should be understood that the present inventive concept is not limited to these embodiments, but may be modified by those skilled in the art without departing from the spirit and scope of the present inventive concept.

What is claimed is:

1. A substrate treating system comprising:
a plurality of process facilities respectively comprising a transfer module including a transfer robot, and a treating module connected to the transfer module;
a buffer station located between each of adjacent transfer modules,
wherein the plurality of process facilities comprises:
at least one first facility, wherein the treating module is located on a first side of an imaginary line provided along a direction in which the transfer modules and the buffer stations are arranged; and
at least one second facility, wherein the treating module is located on a second side of the imaginary line, wherein the transfer module of the first facility protrudes toward the first side of the imaginary line farther than the transfer module of the second facility.

2. The substrate treating system of claim 1, wherein the transfer module of the first facility protrudes toward the first side of the imaginary line farther than the buffer station.

3. The substrate treating system of claim 2, wherein the transfer module of the second facility protrudes toward the second side of the imaginary line farther than the buffer station and the transfer module of the first facility.

4. The substrate treating system of claim 1, wherein one second facility is located between adjacent first facilities.

5. The substrate treating system of claim 4, wherein a width of the treating module of the second facility parallel is greater than a width of the transfer module of the second facility.

6. The substrate treating system of claim 4, wherein a width of the treating module of the second facility is greater than the sum of a width of the transfer module of the second facility and a combined width of buffer stations located on two sides of the transfer module of the second facility.

7. The substrate treating system of claim 5, wherein the first and second process facilities have a same size and a same shape.

8. The substrate treating system of claim 1, wherein each of the process facilities further comprises at least one load port combined with the transfer module, wherein a first side of the transfer module that is combined with the treating module faces, with respect to the connection the line, a second side of the transfer module that is combined with the load port.

9. The substrate treating system of claim 8, further comprising a first guide rail facing the load port of the first facility and guiding movement of a transfer device for transferring a vessel including substrates to the load port of the first facility.

10. The substrate treating system of claim 9, further comprising a second guide rail facing the load port of the second facility and guiding movement of a return device returning a vessel including substrates to the load port of the second facility.

11. The substrate treating system of claim 1, wherein at least one process facility of the plurality of process facilities further comprises:
at least one load port connected to a side of the transfer module facing another side of the transfer module to which the treating module is connected, wherein a vessel including substrates is placed on the at least one load port; and
a process treating device located opposite to the transfer module with respect to the load port and connected to the load port.

12. The substrate treating system of claim 1, wherein at least one of the plurality of process facilities further comprises another treating module connected to a side of the transfer module opposite a side of the transfer module to which the treating module is connected.

13. The substrate treating system of claim 1, wherein the buffer station comprises:
a housing; and
a buffer disposed in the housing and on which a substrate is placed, wherein the housing is elastic.

14. A substrate treating system comprising:
a first transfer module including a first transfer robot;
a second transfer module including a second transfer robot;
a first buffer station disposed between the first transfer module and the second transfer module;
a first treating module combined with the first transfer module wherein the first treating module is disposed on a first side of an imaginary line extending in a direction in which the first transfer module, the first buffer station and the second transfer module are arranged;
a second treating module combined with the second transfer module, wherein the second treating module is disposed on a second side of the imaginary line,
wherein the first transfer module protrudes toward the first side of the imaginary line farther than the second transfer module.

15. The substrate treating system of claim 14, further comprising:
a third transfer module including a third transfer robot, wherein the third transfer module is disposed opposite to the first transfer module with respect to the second transfer module;
a second buffer station disposed between the second transfer module and the third transfer module;
a third treating module disposed on the first side of the imaginary line and combined with the third transfer module,
wherein the third transfer module protrudes toward the first side of the connection line farther than the second transfer module.

16. The substrate treating system of claim 15, wherein the second transfer module protrudes toward the second side of the imaginary line farther than the first transfer module and the third transfer module.

17. The substrate treating system of claim 16, wherein the first transfer module protrudes toward the first side of the imaginary line farther than the first buffer station, and wherein the second transfer module protrudes toward the second side of the imaginary line farther than the first buffer station, the second buffer station, the first transfer module and the third transfer module.

18. The substrate treating system of claim 17, wherein a distance that the first transfer module protrudes toward the second side of the imaginary line is equal to a distance that the first transfer module protrudes toward the first buffer station and the second buffer station, and wherein a distance that the second transfer module protrudes toward the first side of the imaginary line is equal to a distance that the second transfer module protrudes toward the first buffer station and the second buffer station.

19. A substrate treating system, comprising:
a first transfer module;
a second transfer module;
a buffer station interposed between the first and second transfer modules, wherein the first and second transfer modules, and the buffer station are arranged along an imaginary line extending along a first axis;
a first treating module disposed on a first side of the imaginary line along a second axis perpendicular to the first axis; and
a second treating module disposed on a second side of the imaginary line along the second axis, wherein a side of the first transfer module on the first side of and extending parallel to the imaginary line is farther from the imaginary line than a side of the second transfer module on the first side of and extending parallel to the imaginary line.

20. The substrate treating system of claim 19, wherein a side of the second transfer module on the second side of and extending parallel to the imaginary line is farther from the imaginary line than a side of the first transfer module on the second side of and extending parallel to the imaginary line.
